(19) United States
(12) Patent Application Publication
(10) Pub. No.: US 2026/0202599 A1
(43) Pub. Date: Jul. 16, 2026

(54) POLARIZING PLATE, LIQUID CRYSTAL PANEL USING SAME, AND PHOTOFABRICATION APPARATUS

(71) Applicant: NIPPON KAYAKU KABUSHIKI KAISHA, Chiyoda-Ku, Tokyo (JP)

(72) Inventors: Yoshitaka Takeichi, Joetsu (JP); Masaharu Hashizume, Joetsu (JP); Komei Narita, Joetsu (JP); Kouichi Tanaka, Joetsu (JP)

(21) Appl. No.: 19/138,153

(22) PCT Filed: Dec. 25, 2023
(86) PCT No.: PCT/JP2023/046337

§ 371 Date: Jun. 12, 2025

(30) Foreign Application Priority Data
Dec. 27, 2022 (JP) 2022-209115

(51) Int. Cl. G02B 5/30; C09B 31/072; C09B 31/14; G02F 1/1335

(52) U.S. Cl. CPC G02B 5/305; C09B 31/072; C09B 31/14; G02F 1/133536

(57) ABSTRACT

Provided is a polarizing plate that is for use in a liquid crystal shutter of a photofabrication apparatus, said polarizing plate including an absorption-type polarizer in which a dichroic dye is oriented, the absorption-type polarizer having a maximum absorption wavelength in the wavelength range of 370-470 nm, and the polarizing plate having a weighted parallel transmittance Xp₃₈₀₋₄₄₀ of not less than 20% and a weighted orthogonal transmittance Xc₃₈₀₋₄₄₀ of 0.0001-0.1%.

### TECHNICAL FIELD

The present invention relates to a polarizing plate, a liquid crystal panel using the same, and a photofabrication apparatus.

### BACKGROUND ART

A three-dimensional fabrication apparatus is generally referred to as a three-dimensional (3D) printer and has been widely used in recent years as an application of printing technology in various model manufacturing, architecture and other applications. Specifically, a three-dimensional fabrication apparatus can form a three-dimensional fabricated object by sequentially laminating resin materials or the like using computer-aided design (CAD) data of the object.

One of the methods for three-dimensional fabrication apparatus is a photofabrication method that cures resin using light (hereinafter, referred to as the “photofabrication method”, and a three-dimensional fabrication apparatus using the photofabrication method is referred to as a “photofabrication apparatus”). In a photofabrication method, generally, light from a light source includes ultraviolet light (ultraviolet rays), and a photo-curable resin is intermittently and selectively irradiated with the light to cure and laminate the resin. By repeating this process, a fabricated object is formed. As a light source, a light-emitting diode having a maximum emission wavelength in the range of 380 to 440 nm is typically used.

In some cases, a liquid crystal shutter may be used as a control member for intermittently and selectively emitting light from the light source. The liquid crystal shutter is composed of a liquid crystal panel that includes a liquid crystal cell and a polarizing plate. A photofabrication apparatus using a liquid crystal shutter is disclosed, for example, in Patent Documents 1 to 4. Such photofabrication apparatus has a simple configuration, making it suitable for miniaturization, and is also capable of forming precise and highly accurate three-dimensional fabricated objects.

Incidentally, the polarizing plate used in the liquid crystal shutter is generally the same type as those used in monitor displays, liquid crystal televisions and the like. A polarizing plate with polarization characteristics over the entire visible light (wavelength range of 380 to 780 nm, particularly 400 to 700 nm) is used. In particular, from the viewpoint of versatility, an iodine-based polarizing plate is used. This type of polarizing plate uses a polarizer in which iodine is adsorbed and oriented in a polyvinyl alcohol (hereinafter, referred to as PVA)-based resin film as a dichroic colorant.

### PRIOR ART DOCUMENTS

### Patent Document

Patent Document 1: JP 04-156325 A
Patent Document 2: JP 05-329941 A
Patent Document 3: JP 07-232383 A
Patent Document 4: JP 2022-62540 A
Patent Document 5: JP 2018-521341 A

### SUMMARY OF INVENTION

### Technical Problem

The above-mentioned polarizing plate generally contains an ultraviolet absorber in the support laminated for protecting the polarizer, which absorbs light around a wavelength of 380 nm. As a result, the transmittance of the polarizing plate decreases as the wavelength becomes shorter than 430 nm, and at a wavelength of 400 nm, the parallel transmittance is 10% or less, requiring an increase in the illuminance of the light source to obtain the required light amount for curing the resin in the photofabrication apparatus. However, increasing the illuminance of the light source not only leads to higher power consumption, but also promotes the degradation of the polarizing plate due to the heat and irradiation energy from the light source, causing the polarizing plate to turn brown. This causes a phenomenon that further reduces the transmittance of the polarizing plate.

In addition, by using a support that does not include an ultraviolet absorber in the polarizing plate, it is possible to secure transmittance on the shorter wavelength side while reducing the light source illuminance. However, an iodine-based polarizing plate with such a support has not been applied because of the problem of significantly accelerated degradation of the polarizer due to direct exposure of light to the polarizer, including ultraviolet light.

Patent Document 5 discloses a photofabrication apparatus including a liquid crystal panel. Patent Document 5 describes a configuration in which a gap is provided between a first polarizer (light source side) and a liquid crystal cell, or between the first polarizer and a light source, for convection cooling, in response to the heat problem that the first polarizer receives when light with a wavelength range of 380 to 420 nm from the apparatus light source enters the liquid crystal panel. However, the disclosed configuration cannot avoid the light degradation that the first polarizer receives, and also, due to the installation of the convection cooling mechanism, a problem is that the entire device becomes larger.

Therefore, in such photofabrication apparatus using those liquid crystal panels, a problem is that the liquid crystal panels with degraded polarizing plates must be frequently replaced to maintain sufficient photocurability of the resin. If the amount of light emitted from the light source can be reduced without compromising the light amount required for fabricating, the power consumption can be reduced, while delaying the degradation of the polarizing plates, thereby increasing the operating time of the photofabrication apparatus.

An object of the present application is to provide a polarizing plate for a liquid crystal panel for use in a photofabrication apparatus, which bas high polarization characteristics in the wavelength range of the light source of that apparatus, and also has higher durability under exposure to the light.

### Solution to Problem

As a result of extensive research to solve the above-mentioned problem, the present inventors have discovered a polarizing plate with polarization characteristics suitable for light in the wavelength range of 380 to 440 nm, which is used in photofabrication apparatuses. The present invention has been thereby completed.

The present application relates to the following inventions, but is not limited thereto.

### [Invention 1]

A polarizing plate for use in a liquid crystal shutter of a photofabrication apparatus,
wherein the polarizing plate comprises an absorption-type polarizer in which a dichroic colorant is oriented,
the absorption-type polarizer has a maximum absorption wavelength in a wavelength range of 370 to 470 nm, and
the polarizing plate has an Xp₃₈₀₋₄₄₀ of 20% or more as determined by Expression (1), and an Xc₃₈₀₋₄₄₀ of 0.0001 to 0.1% as determined by Expression (2):

$$\begin{matrix}[ Expression 1 ] & \\ {X}_{P 380 - 440} = \frac{{\int }_{380}^{440} Tp ( λ ) S ( λ ) d λ}{{\int }_{380}^{440} S ( λ ) d λ} \times 100 & ( 1 )\end{matrix}$$

$$\begin{matrix}[ Expression 2 ] & \\ {X}_{C 380 - 440} = \frac{{\int }_{380}^{440} Tc ( λ ) S ( λ ) d λ}{{\int }_{380}^{440} S ( λ ) d λ} \times 100 & ( 2 )\end{matrix}$$

wherein Xp₃₈₀₋₄₄₀ is the weighted parallel transmittance calculated in a wavelength range of 380 nm to 440 nm; Xc₃₈₀₋₄₄₀ is a weighted cross transmittance calculated in a wavelength range of 380 nm to 440 nm; Tp(λ) is a parallel transmittance of the polarizing plate at each wavelength; Tc(λ) is a cross transmittance of the polarizing plate at each wavelength; and S(λ) is a light source illuminance normalized at the maximum illuminance.

### [Invention 2]

The polarizing plate according to Invention 1, comprising, as the dichroic colorant, at least one of azo compounds described in the following Formulas (1) to (3) or salts thereof:

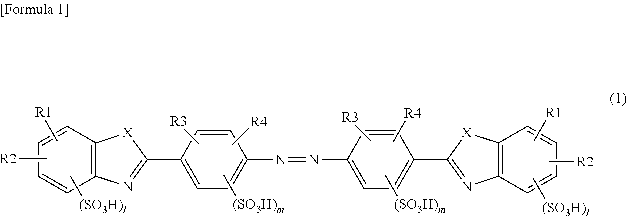

wherein Formula (1) is expressed in the form of a free acid, wherein R1 and R2 represent a hydrogen atom, a halogen atom, a lower alkyl group, a lower alkoxy group, or a carboxyl group; R3 and R4 represent a hydrogen atom, a halogen atom, a lower alkyl group, a lower alkoxy group, or a hydroxyl group; and X represents O, S, NH or NCH₃; and l and m represent 0, 1, or 2, and 1+m>0;

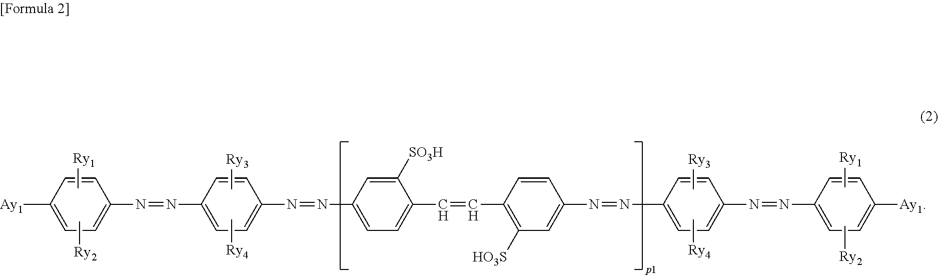

wherein Formula (2) is expressed in the form of a free acid, wherein Ay₁ represents a sulfo group, a carboxyl group, a hydroxyl group, an alkyl group having 1 to 4 carbon atoms, or an alkoxy group having 1 to 4 carbon atoms; Ry₁ to Ry₄ each independently represent a hydrogen atom, a sulfo group, an alkyl group having 1 to 4 carbon atoms, or an alkoxy group having 1 to 4 carbon atoms; and p1 is an integer of 1 to 3;

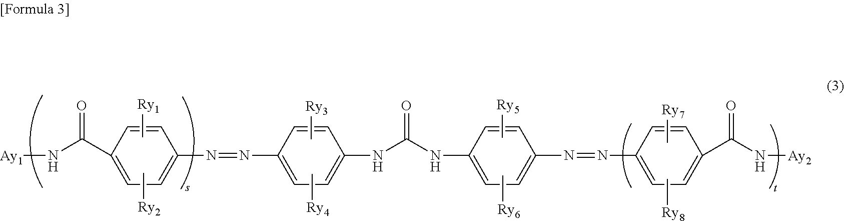

wherein Formula (3) is expressed in the form of a free acid, wherein Ay1 and Ay2 are each independently a naphthyl group optionally having a substituent, or a phenyl group optionally having a substituent; s and t are each independently 0 or 1; and either s or tis 1; and Ry₁ to Ry₈ are each independently a hydrogen atom or a substituent.

### [Invention 3]

The polarizing plate according to Invention 1 or Invention 2 comprising a reflection-type polarizer, wherein the reflection-type polarizer and the absorption-type polarizer are laminated so that transmission axes thereof are parallel.

### [Invention 4]

A liquid crystal panel with a TFT driving type, comprising the polarizing plate according to Invention 1 or Invention 2.

### [Invention 5]

A photofabrication apparatus comprising the liquid crystal panel according to Invention 4 and an LED light source,
wherein the liquid crystal panel controls transmittance of light emitted from the light source;
the light transmitted through the liquid crystal panel cures photo-curable resin; and
the cured resin is sequentially laminated to form a three-dimensional fabricated object.

### [Invention 6]

A liquid crystal panel comprising the polarizing plate according to Invention 1 or Invention 2,
wherein the liquid crystal panel is of TFT driving type;
the liquid crystal panel has an incident side of light source and an emission side of light source; and
the polarizing plate provided on the incident side comprises a reflection-type polarizer; and
the reflection-type polarizer and the absorption-type polarizer are laminated so that transmission axes thereof are parallel.

### [Invention 7]

A photofabrication apparatus comprising the liquid crystal panel according to Invention 6 and an LED light source,
wherein the liquid crystal panel controls transmittance of light emitted from the light source;
the light transmitted through the liquid crystal panel cures a photo-curable resin; and
the cured resin is sequentially laminated to form a three-dimensional fabricated object.

### [Invention 8]

A polarizing plate for use in an optical path between a liquid crystal panel of a photofabrication apparatus and a light source,
wherein the polarizing plate comprises an absorption-type polarizer in which a dichroic colorant is oriented,
the absorption-type polarizer has a maximum absorption wavelength in a wavelength range of 370 to 470 nm; and
the polarizing plate has an Xp₃₈₀₋₄₄₀ of 30 to 70% as determined by Expression (1), and an Xc₃₈₀₋₄₄₀ of 0.1 to 65% as determined by Expression (2):

$$\begin{matrix}[ Expression 3 ] & \\ {X}_{P 380 - 440} = \frac{{\int }_{380}^{440} Tp ( λ ) S ( λ ) d λ}{{\int }_{380}^{440} S ( λ ) d λ} \times 100 & ( 1 )\end{matrix}$$

$$\begin{matrix}[ Expression 4 ] & \\ {X}_{C 380 - 440} = \frac{{\int }_{380}^{440} Tc ( λ ) S ( λ ) d λ}{{\int }_{380}^{440} S ( λ ) d λ} \times 100 & ( 2 )\end{matrix}$$

wherein Xp₃₈₀₋₄₄₀ is a weighted parallel transmittance calculated in a wavelength range of 380 nm to 440 nm; Xc₃₈₀₋₄₄₀ is a weighted cross transmittance calculated in a wavelength range of 380 nm to 440 nm; Tp(λ) is a parallel transmittance of the polarizing plate at each wavelength; Tc(λ) is a cross transmittance of the polarizing plate at each wavelength; and S(λ) is a light source illuminance normalized at the maximum illuminance.

### [Invention 9]

The polarizing plate according to Invention 8, wherein the dichroic colorant contains at least one of azo compounds of (1) to (3) or salts thereof:

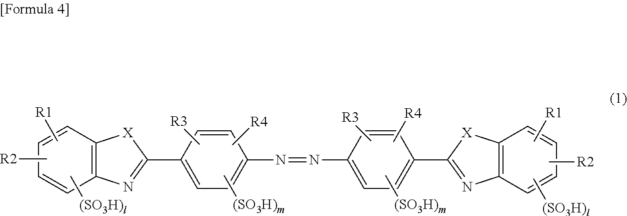

wherein Formula (1) is expressed in the form of a free acid, wherein R1 and R2 represent a hydrogen atom, a halogen atom, a lower alkyl group, a lower alkoxy group, or a carboxyl group; R3 and R4 represent a hydrogen atom, a halogen atom, a lower alkyl group, a lower alkoxy group, or a hydroxyl group; and X represents O, S, NH or NCH₃; and l and m represent 0, 1, or 2; and 1+m>0;

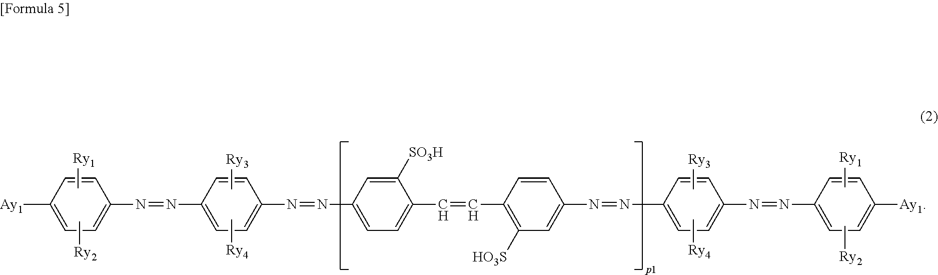

wherein Formula (2) is expressed in the form of a free acid, wherein Ay₁ represents a sulfo group, a carboxyl group, a hydroxyl group, an alkyl group having 1 to 4 carbon atoms, or an alkoxy group having 1 to 4 carbon atoms; Ry₁ to Ry₄ each independently represent a hydrogen atom, a sulfo group, an alkyl group having 1 to 4 carbon atoms; or an alkoxy group having 1 to 4 carbon atoms, and p1 is an integer of 1 to 3;

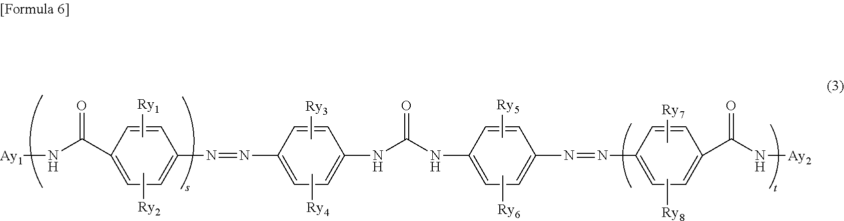

wherein Formula (3) is expressed in the form of a free acid, wherein Ay₁ and Ay₂ are each independently a naphthyl group optionally having a substituent, or a phenyl group optionally having a substituent; s and t are each independently 0 or 1; and either s or tis 1; and Ry₁ to Ry₈ are each independently a hydrogen atom or a substituent.

### [Invention 10]

A photofabrication apparatus comprising a liquid crystal panel with a TFT driving type, an LED light source, and the polarizing plate according to Invention 8 or 9,
wherein the liquid crystal panel comprises the polarizing plate according to Invention 1 or 2; and
at least one polarizing plate according to claim 8 or 9 is provided as a pre-polarizing plate in the optical path between the liquid crystal panel and the LED light source, so that the transmittance of light emitted from the light source is controlled by the liquid crystal panel to cure a photo-curable resin, and the cured resin is sequentially laminated to form a three-dimensional fabricated object.

### Advantageous Effects of Invention

The present invention can provide a polarizing plate for a liquid crystal panel for use in a photofabrication apparatus, which has high polarization characteristics in the wavelength range of the light source of that apparatus, and also has higher durability under exposure to the light.

In addition, by incorporating a liquid crystal panel using such a polarizing plate into a photofabrication apparatus, it is possible to enable stable light irradiation for a long time, thereby reducing the frequency of replacement of the liquid crystal panel, and to provide a photofabrication apparatus.

### BRIEF DESCRIPTION OF DRAWINGS

FIG. 1 is an example of a cross-sectional view of a polarizing plate of the present invention.

FIG. 2 is other example of a cross-sectional view of the polarizing plate of the present invention.

FIG. 3 is an example showing the wavelength dependence of the illuminance of an apparatus light source used in a photofabrication apparatus.

FIG. 4 is a configuration example of a photofabrication apparatus equipped with a liquid crystal panel using the polarizing plate of the present invention.

FIG. 5 is other configuration example of the photofabrication apparatus equipped with the liquid crystal panel using the polarizing plate of the present invention.

### DESCRIPTION OF EMBODIMENTS

Hereinafter, embodiments according to the present invention will be described in detail. Note that, the embodiments described below are examples of several representative embodiments of the present invention, and various modifications can be made within the scope of the present invention.

In the claims and specification of the present application, the term “substituent” may include a hydrogen atom, and for convenience, a hydrogen atom may sometimes be described as a “substituent”. The phrase “optionally having a substituent” means that the case in which no substituent is also included. For example, the “phenyl group optionally having a substituent” includes both a non-substituted simple phenyl group and a phenyl group with a substituent. Also, unless otherwise specified, the term “lower” as used to refer to lower alkyl groups, lower alkoxy groups, and the like of the present application, indicates that the number of carbon atom is 1 to 4 (C1 to 4), preferably 1 to 3 (C1 to 3).

As “lower (C1 to 4) alkyl groups”, examples include linear alkyl groups such as a methyl group, an ethyl group, a n-propyl group, and a n-butyl group, branched alkyl groups such as sec-butyl groups and tert-butyl groups, as well as unsaturated hydrocarbon groups such as vinyl groups.

As “lower (C1 to 4) alkoxy groups”, examples include a methoxy group, an ethoxy group, a propoxy group, a n-butoxy group, a sec-butoxy group, and a tert-butoxy group.

In this specification, the term “azo compound” or “azo compound or salts thereof” may be used for abbreviation to collectively refer to “azo compounds, metal complex compounds thereof, or salts thereof”.

### <Polarizing Plate>

The polarizing plate of the present invention includes a polarizer and at least one support, and this configuration is referred to as a polarizing plate. As the polarizer, an absorption-type polarizer that vibrates light vibrating in all directions in one direction only while shielding or absorbing light that vibrates in other directions can be used. Furthermore, a reflection-type polarizer, as described later, may also be combined. A reflection-type polarizer refers to a polarizer that vibrates light vibrating in all directions in one direction only while reflecting light that vibrates in other directions.

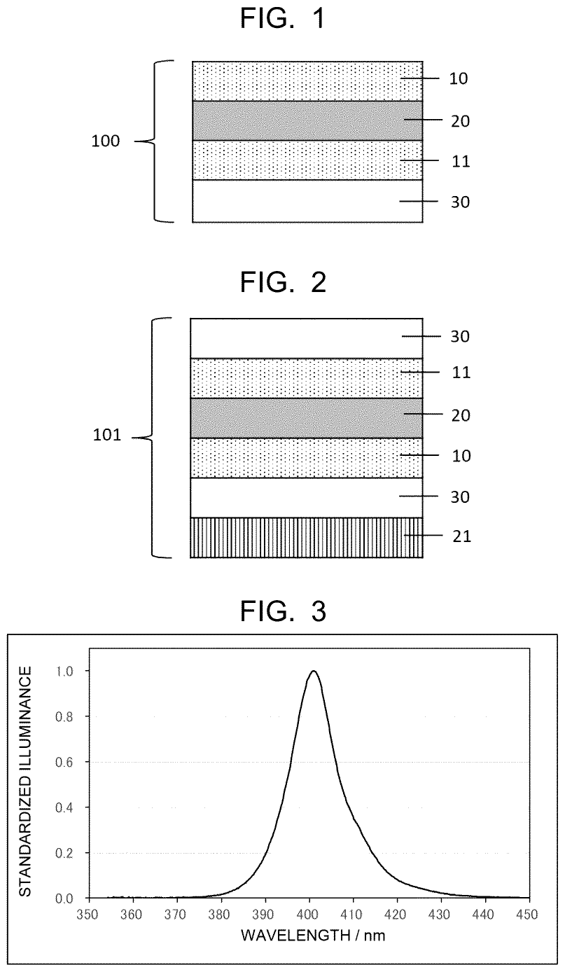

The polarizing plate 100 includes a support 10 and 11, and an absorption-type polarizer 20, as shown in FIG. 1. It may include an adhesive layer 30 for bonding with other members. The layers are disposed in the order of the first support 10/adhesive layer (not shown)/absorption-type polarizer 20/adhesive layer (not shown)/second support 11/pressure-sensitive adhesive layer 30. As an other aspect, as shown in FIG. 2, the polarizing plate 101 may be configured as the second support 11/adhesive layer (not shown)/absorption-type polarizer 20/adhesive layer (not shown)/first support 10/pressure-sensitive adhesive layer 30/reflection-type polarizer (polarizing plate) 21. The pressure-sensitive adhesive layer 30 for bonding with other members may be provided on the outer side (outer side of the second support 11 in FIG. 2). Here, the reflection-type polarizer (polarizing plate) 21 is positioned on the incident side of the light source in the photofabrication apparatus.

The optical characteristics of the polarizer will be described. It is preferable that the wavelength dependency of the polarization characteristics of the polarizer covers the wavelength range of the light from the light source provided in the photofabrication apparatus. For example, if the light from the light source has an illuminance peak around wavelength of 400 nm, with a bandwidth of +50 nm from that peak, the polarizer correspondingly preferably includes a dichroic colorant having a maximum absorption wavelength (referred to as Amax) around 400 nm and preferably has polarization characteristics in the wavelength range of at least 370 nm to 470 nm. Furthermore, having a polarization characteristic bandwidth of +10 nm or more, preferably +30 nm or more, and more preferably +50 nm or more, relative to the wavelength bandwidth of the light source, ensures that the photofabrication apparatus can obtain a liquid crystal panel with no leakage light from the light source. The leakage light from the liquid crystal panel may cause unintended gelling or curing of the photo-curable resin filled in the resin tray at unintended position or timing.

### (Absorption-Type Polarizer)

When the light source has an illuminance peak around a wavelength of 400 nm, the degree of polarization (P) at that wavelength, the polarization characteristics of the absorption-type polarizer is preferably 95% or more, more preferably 97% or more, and still more preferably 99% or more. In this case, from the viewpoint of the light utilization efficiency of the liquid crystal shutter in the photofabrication apparatus, the parallel transmittance (Tp) is preferably 20% or more, and more preferably 30% or more. In addition, the cross transmittance (Tc) is preferably 0.1% or less, and more preferably 0.01% or less.

The absorption-type polarizer typically includes polarizing films made from stretched polyvinyl alcohol (PVA)-based resin, and coating process (also referred to as coating type) polarizing films. In particular, polyvinyl alcohol (PVA)-based polarizing films, which the alignment substrate thereof is PVA-based resin, can be suitably used. Commercially available PVA-based films include, for example, VF-PS #7500 (thickness 75 μm), VF-PE #4000 (thickness 40 μm), produced by Kuraray Co., Ltd.

The method for producing the above PVA-based resin polarizing film can be applied by the known stretching method. The film is manufactured by adsorbing a dichroic colorant onto a polymer film containing PVA or derivatives thereof, and then uniaxially stretching and orienting the film approximately 2 to 6 times. At this time, the film thickness of the polarizer is generally between 5 and 35 μm. Examples of dichroic colorant typically include iodine or dye. From the viewpoint of heat resistance and light resistance, dichroic dye is preferable, and particularly, direct dye containing azo colorant with sulfonic acid group is preferred.

A polarizing plate using an absorption-type polarizer with oriented dyes is hereinafter referred to as a dye-based polarizing plate. In the manufacture of dye-based polarizing plate, such dyes are used in a color mixture. Generally, based on the principle of the primary colors of light, at least three types of colorants are used, each having a Amax in the wavelength bandwidth of 380 to 430 nm, 430 to 580 nm, and 580 to 680 nm, to design any hue such as gray or brown.

The above colorants generally have, in addition to the main absorption wavelength range having Amax, a secondary absorption wavelength range. Depending on the blending combination of the dyes, the secondary absorption wavelength range may overlap with the main absorption wavelength range of other colorants, potentially lowering the optical characteristics of the main absorption wavelength range of other dyes. Therefore, as the dichroic colorant used in the absorption-type polarizer, it is preferable that the colorant has polarization characteristics that cover the wavelength range of the light source of the photofabrication apparatus and are oriented on at least one substrate. When using two or more colorants, it is desirable for the Amax of each colorant to be equal or closely located. Specifically, it is preferable that the wavelength interval between the Amax of each colorant be within 30 nm, more preferable within 20 nm, and still more preferable within 10 nm.

The wavelength range of the light source of the photofabrication apparatus generally has an emission wavelength range of at least 380 to 440 nm, as shown in FIG. 3, with the peak emission wavelength located in the range of 390 to 410 nm. Here, the emission wavelength range refers to the wavelength end regions with emission illuminance, and the peak emission wavelength means that the wavelength with the highest emission illuminance in the region.

Therefore, the colorant used in the polarizer is selected to have high polarization characteristics in that emission wavelength range, with Amax located around that wavelength. Specifically, the wavelength range of in which that Amax is included is preferably in the range of wavelength 370 to 470 nm, more preferably in the wavelength range of 375 to 465 nm, and still more preferably in the wavelength range of 380 to 440 nm. Such colorants are perceived as yellow or orange when used as polarizers. The hue of the polarizer can be determined by performing spectroscopic measurement and using the L*a*b* color system (JIS Z 8781-4). In addition, in the production of the polarizer, these colorants are desirably used alone from the viewpoint of the above-mentioned secondary absorption wavelength range. The optical characteristics can be designed by adjusting the colorant concentration, dyeing time, and the like, to match the liquid crystal shutter performance required for the photofabrication apparatus. Typically, the dye concentration of the dyeing solution in the stretching process is in the range of 0.01 to 0.1 mass %.

Examples of the dichroic colorant include the azo compound represented by following Formula (1) or salts thereof disclosed in International Publication WO 2005/015275, as well as C.I. Direct Yellow 28. The range of λ max in the polarizer is in the wavelength range of 400 to 415 nm.

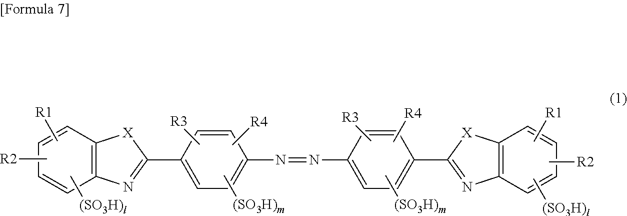

(Formula (1) is expressed in the form of a free acid, wherein R1 and R2 represent a hydrogen atom, a halogen atom, a lower alkyl group, a lower alkoxy group, or a carboxyl group, R3 and R4 represent a hydrogen atom, a halogen atom, a lower alkyl group, a lower alkoxy group, or a hydroxyl group, and X represents O, S, NH or NCH₃. In addition, l and m represent 0, 1, or 2, and 1+m>0.)

Examples of other dichroic colorants include the azo compound represented by the following Formula (2) or salts thereof disclosed in International Publication WO 2007/138980, as well as C.I. Direct Orange 39. The range of λmax in the polarizer is in the wavelength range of 445 to 465 nm.

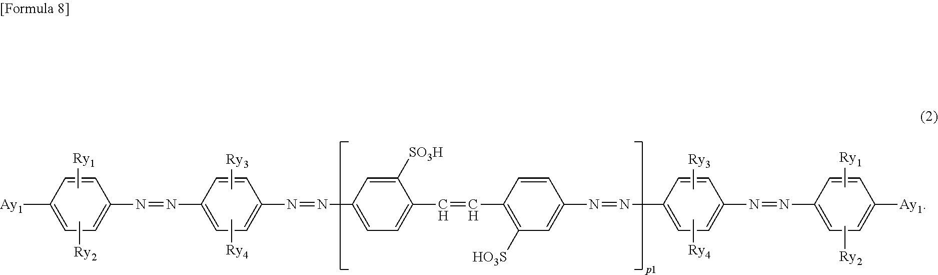

(Where, Formula (2) is expressed in the form of a free acid, Ay₁ represents a sulfo group, a carboxyl group, a hydroxyl group, an alkyl group having 1 to 4 carbon atoms, or an alkoxy group having 1 to 4 carbon atoms, Ry₁ to Ry₄ each independently represent a hydrogen atom, a sulfo group, an alkyl group having 1 to 4 carbon atoms, or an alkoxy group having 1 to 4 carbon atoms, and p1 is an integer of 1 to 3.)

Examples of the other dichroic colorants include the azo compound represented by the following Formula (3) or salts thereof disclosed in International Publication WO 2019/124161. The range of λmax in the polarizer is in the wavelength range of 445 to 465 nm.

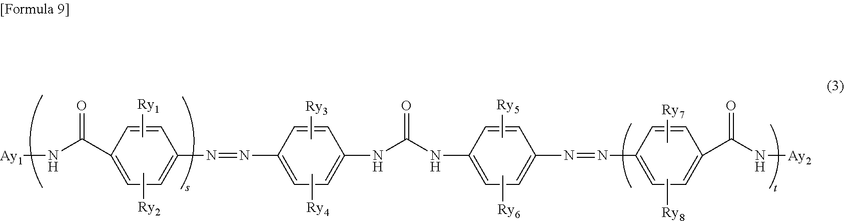

(Where, Formula (3) is expressed in the form of a free acid, Ay₁ and Ay₂ are each independently a naphthyl group optionally having a substituent, or a phenyl group optionally having a substituent, s and t are each independently 0 or 1, and either s or t is 1, and Ry₁ to Ry₈ are each independently a hydrogen atom or a substituent.)

The substituent of the “naphthyl group optionally having a substituent”, is preferably selected from the group consisting of a hydroxyl group, an alkoxy group having 1 to 4 carbon atoms with a sulfo group, and a sulfo group.

The substituent of the “phenyl group optionally having a substituent”, preferably includes an aliphatic hydrocarbon group having 1 to 4 carbon atoms optionally having a substituent; an alkoxy group having 1 to 4 carbon atoms optionally having a substituent; an aryloxy group optionally having a substituent; a hydroxyl group; a sulfo group; a carboxyl group; a substituted or unsubstituted amino group; an amide group, and is selected from the group consisting of an alkoxy group having 1 to 4 carbon atoms optionally having a substituent; a sulfo group; and a carboxyl group.

The above “substituted or unsubstituted amino group” includes, for example, a mono-substituted amino group such as an amino group, a methylamino group, an ethylamino group, a n-propylamino group, a n-butylamino group, a monophenylamino group, and a mononaphthylamino group, as well as a di-substituted amino group such as a dimethylamino group, a diethylamino group, and a diphenylamino group. In addition, these substituted amino groups may further have substituents.

The “substituent” in the above aliphatic hydrocarbon group having 1 to 4 carbon atoms optionally having a substituent and the above alkoxy group having 1 to 4 carbon atoms optionally having a substituent are not particularly limited, and examples include a hydroxyl group, a sulfo group, a carboxyl group, a substituted or unsubstituted amino group, and an amide group. The “substituent” in the aryloxy group optionally having a substituent and the “substituent” that may further be present in the substituted amino group are not particularly limited, and examples include an aliphatic hydrocarbon group having 1 to 4 carbon atoms optionally having a substituent.

More preferably, Ay₁ and Ay₂ in the above Formula (1) are phenyl groups having at least one substituent selected from the group consisting of a sulfo group, a carboxyl group, a lower alkoxy group having a sulfo group, a lower alkyl group, a lower alkoxy group, a halogen atom, a nitro group, an amino group, a lower alkyl-substituted amino group, and a lower alkyl-substituted acylamino group.

The substituents for Ry₁ to Ry₈ are not particularly limited and may be the same as those described in the section on “phenyl group optionally having a substituent” or “naphthyl group optionally having a substituent”.

Other known dyes include, for example,
C.I. Direct Yellow 4,
C.I. Direct Yellow 11,
C.I. Direct Yellow 12,
C.I. Direct Yellow 26,
C.I. Direct Yellow 44,
C.I. Direct Yellow 50,
C.I. Direct Yellow 51,
C.I. Direct Yellow 86,
C.I. Direct Yellow 142,
C.I. Direct Orange 26,
C.I. Direct Orange 72,
C.I. Direct Orange 107.

### (Reflection-Type Polarizer)

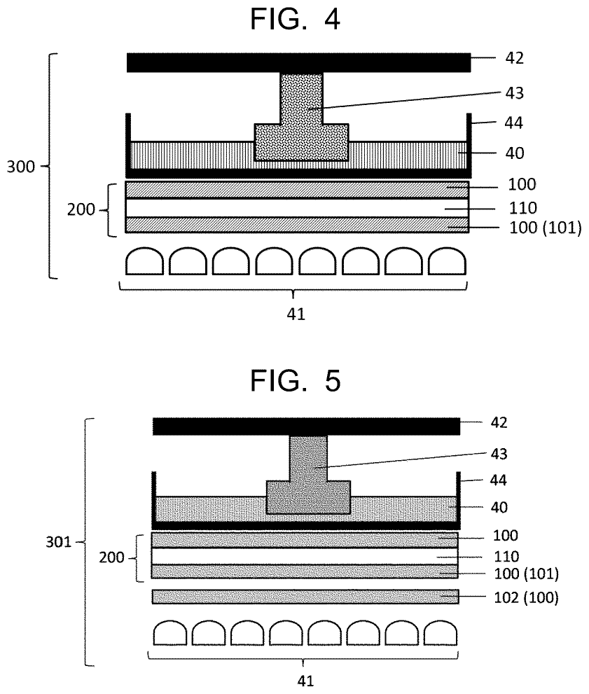

As shown in FIG. 2, the polarizing plate of the present invention may include a reflection-type polarizer in addition to an absorption-type polarizer. The reflection-type polarizer may also be used as a reflection-type polarizing plate that includes a support. Thus, a configuration in which the absorption-type polarizer and the reflection-type polarizer are laminated is hereinafter referred to as a laminate-type polarizing plate. The reflection-type polarizer is laminated so that its transmission axis is parallel to a transmission axis of the absorption-type polarizer, and it is disposed in the liquid crystal panel 200 so that the reflection-type polarizer is on the light source 41 side and is used as a component of the laminate-type polarizing plate 101 in FIG. 4.

As for the reflection-type polarizer, it is particularly desirable to have polarization characteristics in the region of the wavelength of 350 to 450 nm, and an average degree of polarization in this wavelength range is preferably 90% or more, more preferably 95% or more, and still more preferably 99% or more. The polarization in the vibration direction, which would be absorbed by the absorption-type polarizing plate, is reflected by the reflection-type polarizer in advance. This suppresses a decrease in the transmittance of light from the light source while reducing damage to the polarizing plate caused by light in the wavelength range of 350 to 450 nm.

Examples of commercially available reflection-type polarizers with the above-mentioned polarization characteristics include birefringent interference types with multiple layers of differing birefringence and wire grid types. Examples of commercially available products include the brightness enhancement film series (produced by 3M Company) and the wire grid polarizing film WGF series (produced by Asahi Kasei Corporation).

### (Support)

A support (also referred to as a support plate) is a member for mechanically supporting and protecting the polarizer. The support is suitably selected from optically transparent plastic resins, such as triacetylcellulose (TAC)-based resin plates (also referred to as sheets or films), cycloolefin-based resin plates, acrylic-based resin plates, and polycarbonate (PC)-based resin plates. The thickness of the support is preferably 10 μm or more, and more preferably 40 μm or more, respectively. When using the PVA-based resin polarizer in the polarizing plate, the TAC-based resin film is suitably used due to its ease of adhesion.

The support used in the polarizing plate generally contains an ultraviolet absorber to protect the polarizer (particularly iodine-based polarizers) from degradation, as well as to protect the liquid crystal molecules in the liquid crystal cell from degradation caused by ultraviolet light in external light. Examples of ultraviolet absorbers include organic ultraviolet absorbers such as oxybenzophenone compounds, benzotriazole compounds, salicylic acid ester compounds, benzophenone compounds, cyanoacrylate compounds, and nickel complex salt compounds. These materials are generally added either alone or in combination. A support film containing such ultraviolet absorbers generally has natural light transmittances of 10 to 1% at a wavelength of 380 nm, 70 to 40% at a wavelength of 400 nm, and 90 to 80% at a wavelength of 410 nm. When using a polarizing plate for a general liquid crystal display (LCD), the liquid crystal panel will include at least 2 to 4 layers of such support. As a result, the transmittance in this wavelength range will further decrease as the number of layers increases.

The polarizing plate of the present invention is configured as a dye-based polarizing plate having high light resistance, which allows for use for a long time in a photofabrication apparatus without the need for a support containing an ultraviolet absorber as compared to iodine-based polarizing plates. In addition, the polarizing plate of the present invention may include a support containing an ultraviolet absorber, as long as it does not interfere with the light efficiency of the light source, and preferably contains at least one layer. In such a case, the support is preferably disposed on the light source side in the optical path from the light source including the liquid crystal panel of the photofabrication apparatus to the emission of the light source. Specifically, the support is the first support 10 in the polarizing plate 100 of FIG. 1 and the first support 10 in the polarizing plate 101 of FIG. 2. By disposing the support in this way, the decrease in the transmittance of light from the light source is suppressed, while also reducing the damage to the polarizing plate and the liquid crystal cell caused by light from the light source. Therefore, the damage caused by light from the light source is similarly reduced in the polarizing plate on the emission side.

Examples of commercially available TAC-based resin films containing ultraviolet absorbers for use as a support for polarizing plates include TG60, TJ40 (produced by Fujifilm), KC8UX2M, KC4UY, KC6UAW, KC8UAW (produced by Konica Minolta Opt), P980RR, and P960GL (produced by TacBright Optronics Corporation).

The TAC-based resin films containing the ultraviolet absorbers typically have ultraviolet absorption performance at wavelengths of 380 nm or less and minimal absorption of visible light at wavelengths of 400 nm or more. Specifically, the natural light transmittance of these films at a wavelength of 380 nm is 10% or less, preferably 5.0% or less, more preferably 3.0% or less, and particularly preferably 1.0% or less.

Examples of commercially available TAC-based resin films not containing ultraviolet absorbers for use in the support of polarizing plates include ZRD60SL (produced by Fujifilm Co., Ltd.), and 13SG80S-HL (produced by Island Polymer Industries GmbH).

The support may also include known additional functional layers, such as a hard coat layer (HC) for surface protection and an anti-reflection layer (AR=Anti-Reflection, LR=Low-Reflection) for improving transmittance. These additional functional layers may contain ultraviolet absorbers, depending on the disposition of the optical path.

The lamination of the support and polarizer is performed using an adhesive layer. The adhesive layer is used to bond the support and polarizer, or the support and other support, and generally a composition made of resin materials that includes at least a base polymer (hereinafter referred to as the main agent) and a curing aid such as a crosslinking agent. These materials are collectively referred to as adhesives. The adhesive is broadly classified into water-based, solvent-based, or non-solvent-based types, depending on the dilution component. These types are selected appropriately based on the surface characteristics of the adherend and the curing method.

A water-based adhesive typically contains, as components, mainly modified or unmodified PVA, a crosslinking agent having a dialdehyde structure, and water. Modified or unmodified polyvinyl alcohol (PVA) includes PVA resin. Modified PVA includes those obtained by saponifying a copolymer of vinyl ester monomers and copolymerizable monomers, or those obtained by modifying unmodified PVA, such as acetoacetyl-modified PVA. Crosslinking agents having dialdehyde structures include dialdehydes such as glutaraldehyde, succinaldehyde, and malondialdehyde. The content ratio of modified or unmodified PVA in the adhesive composition, based on the total weight of the composition, is preferably 1% by mass or more, more preferably 2% by mass or more, still more preferably 3% by mass or more, and still more preferably 4% by mass or more, from the viewpoint of enhancing the adhesive strength between the polarizer and the support.

As the solvent-based or non-solvent-based adhesives, transparent photo-curable resins or thermosetting resins are preferably used. Examples of main agent include acrylic-based resins, urethane-based resins, epoxy-based resins, silicone-based resins, rubber-based resins, polyvinyl ether-based resins, and polyester-based resins.

### (Pressure-Sensitive Adhesive Layer)

The pressure-sensitive adhesive layer is the layer used to laminate the polarizing plate to the liquid crystal cell, as well as to bond the polarizing plate to the reflection-type polarizer. The adhesive used in the pressure-sensitive adhesive layer is not particularly limited, but it is suitable to use a material that absorbs (buffers) the force exerted on the polarizing plate by thermal stress or other forces.

Examples of adhesives used in the pressure-sensitive adhesive layer, not particularly limited, include adhesive components such as urethane resins blended with isocyanate compounds, epoxy compounds, and the like, as well as acrylic-based resin and polyester-based resin.

When light containing ultraviolet light is emitted onto a liquid crystal panel including a laminated polarizing plate for a long time, the heat generated can cause a change in the transmittance of light due to internal stress in the polarizing plate, resulting in a phenomenon called “light leakage”. When light leakage occurs, it can cause non-uniform contrast on the panel face, which may potentially affect the accuracy during photofabrication. In such case, it is preferable to use an adhesive with adjusted birefringence as the adhesive between the polarizing plate and the liquid crystal cell, as disclosed in JP 2008-144125 A, JP 2008-144126 A, JP 2010-196000 A, and the like.

The thickness of the pressure-sensitive adhesive layer is not particular limited, and it is suitable to set it to a normal thickness considering the physical properties. For example, the thickness of the adhesive layer is preferably 1 μm or more and 50 μm or less, and more preferably 5 μm or more and 25 μm or less.

The method for forming the pressure-sensitive adhesive layer is not particular limited, and can be for example, an adhesive composition made by diluting the solid components of an acrylic-based or polyester-based adhesive with a solvent such as toluene or methyl ethyl ketone (MEK) can be applied to the adherend, and then, after laminating, the applied adhesive composition can be cured.

### <Liquid Crystal Panel, Photofabrication Apparatus>

The liquid crystal panel and photofabrication apparatus of the present invention will be specifically described, but the invention is not limited thereto.

As shown in FIG. 4, the photofabrication apparatus 300 includes at least a light source 41, a platform 42, a resin tray 44 for holding the photo-curable resin 40, and a liquid crystal panel 200. In addition, it is equipped with a processing system for converting electronic data such as CAD information into images on the liquid crystal panel. Furthermore, the outer perimeter of the photofabrication apparatus 300 may be provided with a protective cover and sheet, and the like, that blocks ultraviolet light to prevent the photo-curable resin from curing due to incident external light and to protect the user's eyes from leakage light emitted by the light source 41. Note that, the description of electrical and mechanical aspects related to the driving, control and the like, of the photofabrication apparatus 300 is omitted.

In the photofabrication apparatus 300, the liquid crystal panel 200 serves as a control member for intermittently and selectively emitting light from the light source 41 based on imaged electronic data such as CAD. In this case, it is also referred to as a liquid crystal shutter. The liquid crystal panel includes a liquid crystal cell 110, a polarizing plate 100 (101) disposed on the incident side of the light source 41, and other polarizing plate 100 disposed on the side where the light from the light source 41 is emitted toward the bottom surface of the resin tray 44. The liquid crystal cell 101, the polarizing plate 100, and the laminate-type polarizing plate 101 can be laminated using a pressure-sensitive adhesive layer.

The liquid crystal panel 200 is a configuration in which a polarizing plate 100 and other polarizing plate 100 (101) are sandwiched together. The polarizing plate 100 and other polarizing plate 100 (101) are disposed so that their polarization directions are orthogonal (cross-Nicol). By disposing the polarizing plate 100 and other polarizing plate 100 (101) in this manner and controlling the polarization state of light by changing the alignment state of the liquid crystal for each pixel in the liquid crystal cell 110, the photofabrication apparatus 300 functions as a liquid crystal shutter and can control the light from the light source 41.

The liquid crystal cell 110 (also referred to as a liquid crystal element) is configured to include a liquid crystal layer in which a liquid crystal material is injected and sealed between two alignment films, transparent electrodes for controlling the alignment of the liquid crystal, and a TFT (TFT=Thin Film Transistor) substrate on which drive elements for applying voltage to the transparent electrodes are formed. By adopting a TFT driving type, a high-resolution liquid crystal cell can be achieved, which enables the formation of highly detailed fabricated objects. The liquid crystal cell 100 can adopt various types of liquid crystal cell, such as an IPS (IPS=In-Plane Switching) type, an FFS (FFS=Fringe Field Switching) type, a VA (VA=Vertical Alignment) type, and a TN (TN=Twisted Nematic) type.

The polarizing plate 100 (101) may include a phase difference layer according to the type of the liquid crystal cell 110. In that case, a phase difference layer designed to be ¼ wavelength or ½ wavelength relative to the light source wavelength range may be used. Alternatively, a phase difference layer for viewing angle improvement may be provided to improve the angular dependence of the emitted light, which includes ultraviolet light. The phase difference layer for improving the viewing angle varies depending on the type of the liquid crystal panel used; for a TN-LCD panel, a phase difference layer in which discotic liquid crystals are hybrid aligned may be used; for a VA-LCD panel, a phase difference layer called a negative C-plate may be used; and for an IPS-LCD panel, a combination of two phase difference layers called an A-plate and a positive C-plate, may be used.

In addition, the liquid crystal material used in the liquid crystal cell 110 is desirably capable of controlling polarization in the wavelength range of at least 350 to 450 nm, and preferably in the wavelength range of 380 to 440 nm.

In the photofabrication apparatus, it is sufficient for the liquid crystal cell 110 to be able to control polarization in the above-mentioned wavelength range, so it does not necessarily have a color filter such as RGB. This aspect of liquid crystal cell is also referred to as a monochrome.

The light source 41 is used to emit light that includes a specific emission wavelength range to photo-cure the photo-curable resin. The light source 41 generally emits light that includes ultraviolet light, and is classified into UV-A (wavelength 315 to 400 nm), UV-B (wavelength 280 to 315 nm), and UV-C(wavelength 200 to 280 nm) based on its wavelength range. Since ultraviolet light with shorter wavelength range not only consumes more power but also increases the intensity of the irradiated energy, resulting in greater damage to the apparatus and various members, it is preferable for the light source 41 to be classified as UV-A.

The light source 41 is generally a light-emitting diode (LED), and an LED that emits light containing ultraviolet (UV) light is also referred to as a “UV-LED”. As the emission characteristics of the UV-LED, it can have a light emission wavelength range of 350 to 450 nm, preferably 380 to 440 nm, and the peak emission wavelength in the range of 360 to 420 nm, preferably 380 to 440 nm. Examples of the optical characteristics of commercially available UV-LEDs for light source 41 include:

A light emission wavelength range around 355 to 400 nm with a peak emission wavelength around 367 nm.

A light emission wavelength range around 365 to 420 nm with a peak emission wavelength around 387 nm.

A light emission wavelength range around 375 to 435 nm with a peak emission wavelength around 397 nm.

A light emission wavelength range around 380 to 440 nm with a peak emission wavelength around 405 nm.

A light emission wavelength range around 385 to 450 nm with a peak emission wavelength around 410 nm.

The term “around” takes into account the measurement accuracy of the detection equipment and means including a tolerance of 5 nm or less, for example, 1 to 5 nm, with respect to the emission wavelength range and the peak emission wavelength, respectively.

As shown in FIG. 4, when the light source 41 is, for example, a UV-LED, the light-emitting diode may be disposed directly below the liquid crystal panel 200. In this case, the light-emitting diode is preferably miniaturized and disposed in a planar configuration to match the pixel display information of the liquid crystal cell, and it is preferable for the diode to emit light in coordination with the image information to enhance the contrast through the on/off of the liquid crystal shutter. Such liquid crystal display control technology is generally referred to as local dimming or area dimming.

The platform 42 is a base for holding the fabricated object 43, which is formed by the laminated photo-curable resin. The photofabrication apparatus 300 generally includes a mechanism (also referred to as a lift or elevator mechanism) that, at the beginning of the fabrication process, keeps the platform 42 and the bottom surface of the resin tray 44 in contact. As the laminating process of the fabricated object 43 progresses, the distance between the platform 42 and the bottom surface of the resin tray 44 is increased by a stepper motor or the like. Any surface of the photo-curable resin 40 is irradiated with light containing ultraviolet light via the liquid crystal panel 200, which cures the surface light-irradiated with the photo-curable resin 40 to form a cured layer of the desired thickness. Further, the previous photo-curable resin 40 is supplied onto the cured layer, and this layer is also cured, thereby creating a continuous cured layer with the previous layer. This lamination operation is repeated to obtain a three-dimensional fabricated object 43.

The photo-curable resin 40 is typically a liquid resin (generally referred to as “resin”) that cures in response to light containing ultraviolet light. It includes acrylic-based resins that include (meth)acrylate including monomers or oligomers, epoxy-based resins, photopolymerization initiators that generate photoradicals or ions, photosensitizers, and the like. The photo-curable resin 40 may also contain additives such as any resin colorants and fine particles made of inorganic-based or organic-based materials, depending on the texture and design of the fabricated object.

The resin tray 44 stores and holds the photo-curable resin 40. The bottom surface of the resin tray 44 is made of a material that transmits light containing ultraviolet light from the liquid crystal panel 200.

In addition to those as above-mentioned, the photofabrication apparatus 300 may be equipped with a filter that cuts (=does not transmit) light of a specific wavelength range in the optical path between the liquid crystal panel from the light source 41. For example, the filter is a filter that cuts light with wavelengths 350 nm or less or a filter that cuts light with wavelengths 380 nm or less.

The photofabrication apparatus 300 may also include a polarizing plate 102 (100) between the light source 41 and the liquid crystal panel 200. The polarizing plate 102 (100) is disposed so that the transmission axis of the polarizing plate 102 is parallel to the transmission axis of the polarizing plate 100 provided on the incident side of the light source in the liquid crystal panel 200. Such a polarizing plate arrangement is generally referred to as a “Pre-Polarizing Plate (Pre-Polarizer)”. The pre-polarizing plate is disposed the optical path between the light source 41 and the liquid crystal panel 200, and is used to reduce the degradation of the polarizing plate on the light source side of the liquid crystal cell 200 by receiving direct exposure of light from the light source. At this time, the polarizing plate 102 (100) as the pre-polarizing plate may either be further laminated onto the liquid crystal panel 200, or may be used in a configuration where it is laminated onto a transparent glass substrate and disposed in the optical path.

The pre-polarizing plate may be of the same configuration as the polarizing plate 100. However, it is preferable to use a polarizing plate 102 in which the optical characteristics are optimally designed for the pre-polarizing plate based on the configuration of the polarizing plate 100. Specifically, the optical characteristics of the polarizing plate 102 may be selected based on whether the focus is on the brightness height of the light from the liquid crystal panel, or on delaying the time until the liquid crystal panel degrades due to direct exposure of light from the light source. The optical characteristics are preferably as follows when the light source 41 has an illuminance peak around the wavelength of 400 nm. The transmittance (Ts) at this wavelength is in the range of 40 to 70%, the parallel transmittance (Tp) is in the range of 35 to 65%, the cross transmittance (Tc) is in the range of 0.1 to 63%, and the degree of polarization (P) is preferably in the range of 10 to 99%. In particular, when the former is emphasized, Ts is preferably in the range of 60 to 70%, Tp is in the range of 45 to 65%, Te is in the range of 28 to 63%, and P is in the range of 10 to 50%. When the latter is emphasized, Ts is preferably in the range of 40 to 60%, Tp is in the range of 35 to 50%, Tc is in the range of 0.1 to 30%, and P is in the range of 45 to 99%.

The polarizing plate 102 is based on the manufacturing method of the polarizing plate 100, but to reduce the dye content in the polarizer, the conditions in the manufacturing process (such as the dyeing process and stretching process) can be adjusted, for example, by lowering the dyeing solution concentration or shortening the dyeing time, to obtain the polarizing plate 102.

The surface of the support used for the production of the polarizing plate 102 may have the above-mentioned additional functional layer.

A photofabrication apparatus 301 shown in FIG. 5 is an arrangement example where the polarizing plate 102 is disposed as a pre-polarizing plate between the light source 41 and the liquid crystal panel 200. The polarizing plate 102 can be installed by making contact with the polarizing plate 100 (laminated polarizing plate 101) on the liquid crystal panel 200 side between the light source 41 and the liquid crystal panel 200, or as shown in FIG. 5, it may be installed with a gap. It is preferable to dispose the transmission axis (or absorption axis) of the polarizing plate 102 in parallel to the transmission axis (or absorption axis) of the polarizing plate 100 on the light source 41 side of the liquid crystal panel 200. The polarizing plate 102 may be provided at least one in the optical path between the light source 41 and the liquid crystal panel 200, but to the extent that the design and specifications of the photofabrication apparatus permit, multiple polarizing plates 102 with optimally adjusted optical characteristics may be installed.

In general, photofabrication apparatus has the problem that the members in the optical path may suffer damage due to exposure for a long time to the light from the light source. The main spot of damage is the degradation of the polarizing plate attached to the liquid crystal panel, and if such a phenomenon occurs, it was necessary to replace of the liquid crystal panel. In the case of the photofabrication apparatus 301, by installing the pre-polarizing plate 102 in the optical path between the light source and the liquid crystal panel 200, firstly, the pre-polarizing plate 102 will suffer damage from light irradiation, which helps reduce or delay the degradation of the polarizing plate on the liquid crystal panel 200 side. As a result, only the damaged pre-polarizing plate 102 may be replaced.

Therefore, by equipping the photofabrication apparatus 301 with a polarizing plate 102 as the pre-polarizing plate, in addition to the polarizing plate 100 attached to the liquid crystal panel side, the frequency of replacement of the liquid crystal panel can be reduced, resulting in lower maintenance costs and providing stable use for a long time.

(Evaluation of Polarization Characteristics with Respect to the Light Source)

The evaluation of the polarization characteristics with respect to the light source is preferably determined as the sum of the product of the wavelength range of the light source and the transmittance of the polarizing plate at each wavelength in that wavelength range, as shown in Expression (1) and Expression (2). As mentioned above, light sources such as UV-LED have a specific emission wavelength range. Therefore, when evaluating adaptability of the optical characteristics of the polarizing plate, it may not be accurate to estimate using only the transmittance values at specific wavelengths or the transmittance values that are calculated by conventional visual sensitivity correction. By using Expression (1) and Expression (2) to clarify the relationship between the polarizing plate and the light source, it is possible to determine whether the liquid crystal panel with the applied polarizing plate functions as a liquid crystal shutter, allowing for efficient light transmission without leakage.

$$\begin{matrix}[ Expression 5 ] & \\ {X}_{P 380 - 440} = \frac{{\int }_{380}^{440} Tp ( λ ) S ( λ ) d λ}{{\int }_{380}^{440} S ( λ ) d λ} \times 100 & ( 1 )\end{matrix}$$

$$\begin{matrix}[ Expression 6 ] & \\ {X}_{C 380 - 440} = \frac{{\int }_{380}^{440} Tc ( λ ) S ( λ ) d λ}{{\int }_{380}^{440} S ( λ ) d λ} \times 100 & ( 2 )\end{matrix}$$

The illuminance of the light source wavelength is used as a weighting factor, and the product of the polarizing plate's parallel transmittance and cross transmittance is calculated for each wavelength. In Expression (1), the weighted parallel transmittance Xp (unit: %) means the light utilization efficiency with respect to the light source. For example, when the apparatus light source includes the maximum emission wavelength and the emission wavelength range is from 380 to 440 nm as shown in FIG. 3, it is expressed as Xp₃₈₀₋₄₄₀. In Expression (2), the weighted cross transmittance Xc (unit: %) means the shielding performance of the light source. Similarly, when the emission wavelength range of the apparatus light source is from 380 to 440 nm, it is expressed as Xc₃₈₀₋₄₄₀. The ratio of Xp₃₈₀₋₄₀/Xc₃₈₀₋₄₀, which is the ratio of Xp₃₈₀₋₄₀ to Xc₃₈₀₋₄₄₀, represents the contrast value of the liquid crystal panel that quantifies the display characteristics of the display in both the on and off states. In other words, this ratio can serve as an indicator of the performance of the liquid crystal shutter with respect to the apparatus light source in the photofabrication apparatus.

Here, Tp(λ) is the parallel transmittance or the polarizing plate, Tc(λ) is the cross transmittance of the polarizing plate, and S(λ) is the normalized light source illuminance at the maximum illuminance. However, in Expression (1) and Expression (2), the transmittance of the liquid crystal cell is not taken into account. In addition, Expression (1) and Expression (2) can be modified according to the emission characteristics of the light source by adjusting the calculation range and S(λ), and are not limited to this.

In the photofabrication apparatus, by setting Xp₃₈₀₋₄₄₀ to a higher value, the utilization efficiency of the light source can be enhanced. Therefore, it is preferable to adjust the optical characteristics of the polarizing plate so that Xp₃₈₀₋₄₄₀ is preferably 20% or more, more preferably 25% or more, and still more preferably 30% or more. Furthermore, by setting Xp₃₈₀₋₄₄₀ to a higher value, it is possible to ensure a sufficient light amount for resin curing even when the illuminance of the light source is reduced. In addition, the lower illuminance of the light source can reduce the heat load to the polarizing plate on the light source side and the associated degradation of the polarizing plate. It also contributes to reducing the power consumption of the photofabrication apparatus.

By setting Xc₃₈₀₋₄₄₀ to a smaller value, the shielding property of light from the apparatus light source can be improved. Therefore, it is preferable to adjust the optical characteristics of the polarizing plate so that Xc₃₈₀₋₄₄₀ is preferably in the range of 0.0001 to 0.1%, more preferably in the range of 0.0001 to 0.01%, and particularly preferably in the range of 0.001 to 0.01%. A liquid crystal panel equipped with a polarizing plate adjusted in this manner has a contrast value Xp₃₈₀₋₄₄₀/Xc₃₈₀₋₄₄₀ of 100 to 1000 or more, preferably 10000 or more. This indicates that such a polarizing plate is optimal for use as a liquid crystal shutter member for controlling the light from the apparatus light source in the photofabrication apparatus.

The optical measurement of the polarizing plate can be performed using, for example, a spectrophotometer UH4150 produced by Hitachi High-Tech Science Corporation. The transmittance measurement is performed with natural light as the light source, within the wavelength range of 380 nm to 780 nm as the visible light range. The detection conditions for the transmittance at each wavelength are set to a pitch of 10 nm or less, preferably 5 nm or less. In this measurement, a single test specimen is placed at 0 degrees and 90 degrees with respect to its transmission axis or absorption axis, and the average of the measured transmittances is defined as the single transmittance (Ts, unit: %). The transmittance obtained by laminating two test specimens so that transmission axes or absorption axes thereof are parallel to each other is defined as the parallel transmittance (Tp, unit: %), and the transmittance obtained by laminating two test specimens so that transmission axes or absorption axes thereof cross to each other is defined as the cross transmittance (Tc, unit: %). The transmittances for each wavelength are obtained accordingly. The degree of polarization (P, unit: %) at each wavelength can be calculated from Expression (3).

$$P = {\{ ( Tp - Tc ) / ( Tp + Tc ) \}}^{1 / 2} \times 100 \qquad ( 3 )$$

The transmittances obtained from the above measurement can be used to calculate the visual sensitivity corrected transmittance based on JIS Z 8722:2009. In the present invention, the calculation is performed for a C-light source with a 2-degree field of view, and expressed in terms of the visual sensitivity corrected single transmittance (Ys, unit: %), the visual sensitivity corrected parallel transmittance (Yp, unit: %), the visual sensitivity corrected cross transmittance (Yp, unit: %), and the visual sensitivity corrected degree of polarization (Py, unit: %), respectively. In Expression (3), Py is calculated by replacing Tp and Tc with Yp and Yc, respectively.

Similarly, for the polarizing plate used as a pre-polarizing plate, Xp₃₈₀₋₄₄₀, Xc₃₈₀₋₄₄₀, and Xc₃₈₀₋₄₄₀/Xp₃₈₀₋₄₄₀ may be calculated using Expressions (1) and (2). In the pre-polarizing plate, Xp₃₈₀₋₄₄₀ is preferably in the range of 30 to 70%, and more preferably in the range of 35 to 65%, Xc₃₈₀₋₄₄₀ is preferably in the range of 0.01 to 65%, and more preferably in the range of 0.1 to 63%, and Xc₃₈₀₋₄₄₀/Xp₃₈₀₋₄₄₀ is preferably in the range of 1 to 1000, and more preferably in the range of 1 to 100.

### (Light Resistance Test of Polarizing Plate)

The light resistance test of polarizing plate is a test to evaluate the durability of the polarizing plate under exposure to ultraviolet rays under the usage conditions of an actual photofabrication apparatus, and can be performed as described below, but is not limited to this.

In the test method, for example, the polarizing plate is cut into a square of 5 to 10 cm as a test specimen and adhering it to a glass plate via a pressure-sensitive adhesive layer. A UV-LED lamp with a maximum emission wavelength around 400 nm is used as the light source. The output of the light source is set within the range of 0.1 to 1.5 W/cm², and the distance between the light source and the test specimen is adjusted in the range of 1 to 10 cm. The test specimen is curried out light irradiation on the surface of the polarizing plate for a predetermined time. The evaluation of the test specimen before and after testing, can be performed by spectroscopic measurement (in particular, the change in the transmittance and degree of polarization of the polarizing plate around the light source wavelength range), calculation of the hue value using the L*a*b* color system, visual inspection of appearance, and calculation of Xc₃₈₀₋₄₄₀ and Xp₃₈₀₋₄₄₀ or the like.

### EXAMPLES

Hereinafter, the present invention will be further and specifically described through the following examples, but the present invention is not limited to these examples.

### Example 1

### (1) Preparation of Absorption-Type Polarizer

Based on the synthesis method disclosed in Synthesis Example 1 of International Publication WO 2005/015275, an azo-based dye represented by the following Formula (4) was prepared.

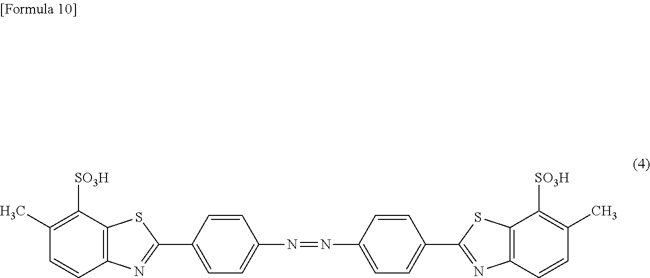

Next, the dye and sodium sulfate were dissolved in water to prepare a dyeing solution. Subsequently, a PVA-based resin film (VF-PS #7500, produced by Kuraray Co., Ltd.) was uniaxially stretched while being immersed in water for swelling. The film was then immersed in the dyeing solution and subsequently stretched in a boric acid aqueous solution, thereby aligning the dye in the resin film. The total uniaxially stretching ratio from swelling to boric acid treatment was set to 6 times. After stretching, the film was dried at 70° C. for 3 minutes in a dryer while maintaining tension, thereby obtaining the absorption-type polarizer. The optical characteristics of the obtained absorption-type polarizer were measured using a UH4150 spectrophotometer produced by Hitachi High-Tech Science Corporation. At a wavelength of 400 nm, the single transmittance Ts₄₀₀ was 38.77%, the parallel transmittance Tp₄₀₀ was 30.06%, the cross transmittance Tc₄₀₀ was 0.0011%, and the degree of polarization P₄₀₀ was 99.99%.

### (2) Preparation of the Polarizing Plate

The polarizer, a first support, and a second support were laminated using a water-based adhesive layer containing a PVA-based resin (Gohsenx Z-200, produced by Mitsubishi Chemical Corporation) (resin solid content is 2.0 wt %). The laminated configuration was then dried in condition at 80° C. for 3 minutes to remove moisture and achieve adhesion, thereby preparing a polarizing plate including supports on both sides of the polarizer. A TAC-based film (13SG80S-LH, film thickness 80 μm produced by Island Polymer Industries GmbH), which had been subjected to saponification treatment (immersion in a 2N sodium hydroxide aqueous solution at 40° C. for 10 minutes) and did not contain an ultraviolet absorber, was used as both the first support and the second support.

The optical characteristics of the obtained polarizing plate were measured using a UH4150 spectrophotometer produced by Hitachi High-Tech Science Corporation. As a result, no difference was observed compared to the optical characteristics of the absorption-type polarizer prepared in (1) of Example 1. These values are shown in Table 1 as the optical characteristics of the polarizing plate.

(3) Evaluation of Polarization Characteristics with Respect to the Light Source

The polarization characteristics of the polarizing plate obtained in (2) of Example 1 were evaluated with respect to the light source using the above-mentioned Expression (1) and Expression (2). In this evaluation, the light source illuminance S(λ) was determined using the emission spectrum of a UV-LED (M405L4, produced by THORLABS Inc.) having a maximum emission wavelength of 405 nm and an emission wavelength range of 380 to 440 nm. The emission illuminance at each wavelength was normalized based on the maximum emission wavelength. From this, Xp₃₈₀₋₄₄₀, Xc₃₈₀₋₄₄₀, and Xp₃₈₀₋₄₄₀/Xc₃₈₀₋₄₄₀ were determined. The evaluation results are shown in Table 1.

### Example 2

### (1) Preparation of Absorption-Type Polarizer

The preparation of the absorption-type polarizer was the same as in (1) of Example 1, except that Kayafect Orange G (produced by Nippon Kayaku Co., Ltd.), a commercially available dye corresponding to C.I. Direct Orange 39, was used. The optical characteristics of the obtained absorption-type polarizer at a wavelength of 400 nm were as follows: Ts₄₀₀ was 39.04%, Tp₄₀₀ was 30.45%, Tc₄₀₀ was 0.0371%, and the degree of polarization P₄₀₀ was 99.88%.

### (2) Preparation of the Polarizing Plate

The polarizing plate was prepared in the same manner as in (2) of Example 1. In the optical characteristics of the obtained polarizing plate, no difference was observed compared to the optical characteristics of the absorption-type polarizer prepared in (1) of Example 2. These values are shown in Table 1 as the optical characteristics of the polarizing plate.

(3) Evaluation of Polarization Characteristics with Respect to the Light Source

The evaluation of the polarization characteristics with respect to the light source were calculated in the same manner as in Example 1, and the evaluation results are shown in Table 1.

### Example 3

### (1) Preparation of Absorption-Type Polarizer

The preparation of the absorption-type polarizer was performed in the same manner as in (1) of Example 2, except that the immersion time in the dyeing solution was increased by 2 to 3 times to lower the transmittance of the obtained polarizer. The optical characteristics of the obtained absorption-type polarizer at a wavelength of 400 nm were as follows: Ts₄₀₀ was 35.58%, Tp₄₀₀ was 25.32%, Tc₄₀₀ was 0.0041%, and P₄₀₀ was 99.98%.

### (2) Preparation of the Polarizing Plate

The polarizing plate was prepared in the same manner as in (2) of Example 1. In the optical characteristics of the obtained polarizing plate, no difference was observed compared to the optical characteristics of the absorption-type polarizer prepared in (1) of Example 3. These values are shown in Table 1 as the optical characteristics of the polarizing plate.

(3) Evaluation of Polarization Characteristics with Respect to the Light Source

The evaluation of the polarization characteristics with respect to the light source were calculated in the same manner as in Example 1, and the evaluation results are shown in Table 1.

### Example 4

### (1) Preparation of Absorption-Type Polarizer

Based on the synthesis method disclosed in Example 1 of International Publication WO 2007/138980, an azo-based dye represented by the following Formula (5) was prepared.

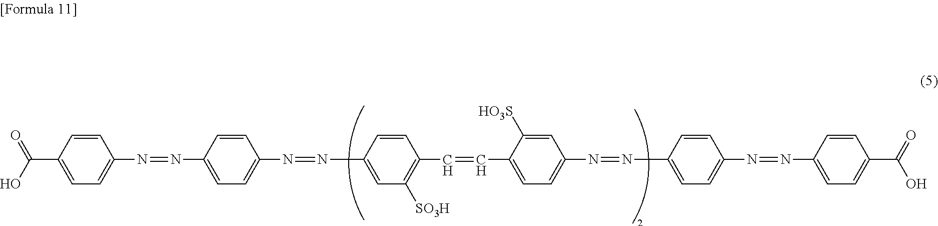

The absorption-type polarizer was prepared in the same manner as in (1) of Example 1, except that the dye was used. The optical characteristics of the obtained absorption-type polarizer at a wavelength of 400 nm were as follows: Ts₄₀₀ was 35.43%, Tp₄₀₀ was 25.07%, Tc₄₀₀ was 0.0400%, and P₄₀₀ was 99.84%.

### (2) Preparation of the Polarizing Plate

The polarizing plate was prepared in the same manner as in (2) of Example 1. In the optical characteristics of the obtained polarizing plate, no difference was observed compared to the optical characteristics of the absorption-type polarizer prepared in (1) of Example 4. These values are shown in Table 1 as the optical characteristics of the polarizing plate.

(3) Evaluation of Polarization Characteristics with Respect to the Light Source

The evaluation of the polarization characteristics with respect to the light source were calculated in the same manner as in Example 1, and the evaluation results are shown in Table 1.

### Example 5

### (1) Preparation of Absorption-Type Polarizer

Based on the synthesis method disclosed in Example B20 of International Publication WO 2019/124161 an azo-based dye represented by the following Formula (6) was prepared.

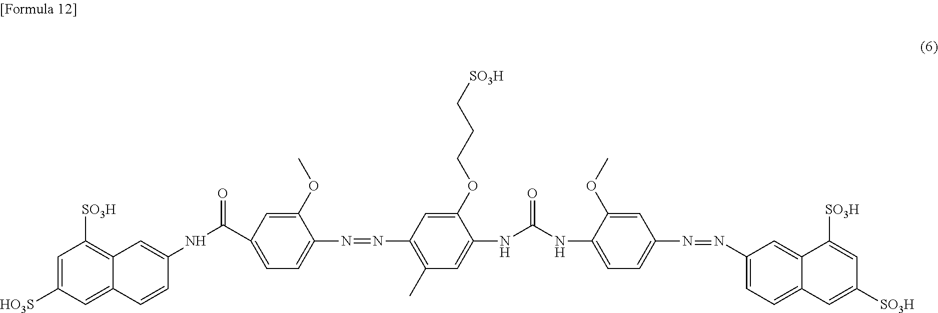 [SMILES: COc1cc(C(=O)Nc2ccc3cc(S(=O)(=O)O)cc(S(=O)(=O)O)c3c2)ccc1N=Nc1cc(OCCCS(=O)(=O)O)c(NC(=O)Nc2ccc(N=Nc3ccc4cc(S(=O)(=O)O)cc(S(=O)(=O)O)c4c3)cc2OC)cc1C]

The absorption-type polarizer was prepared in the same manner as in (1) of Example 1, except that the dye was used. The optical characteristics of the obtained absorption-type polarizer at a wavelength of 400 nm were as follows: Ts₄₀₀ was 35.78%, Tp₄₀₀ was 25.59%, Tc₄₀₀ was 0.0117%, and P₄₀₀ was 99.95%.

### (2) Preparation of the Polarizing Plate

The polarizing plate was prepared in the same manner as in (2) of Example 1. In the optical characteristics of the obtained polarizing plate, no difference was observed compared to the optical characteristics of the absorption-type polarizer prepared in (1) of Example 2. These values are shown in Table 1 as the optical characteristics of the polarizing plate.

(3) Evaluation of Polarization Characteristics with Respect to the Light Source

The evaluation of the polarization characteristics with respect to the light source were calculated in the same manner as in Example 1. The evaluation results are shown in Table 1.

### Example 6

### (1) Preparation of Absorption-Type Polarizer

This is the same as the absorption-type polarizer prepared in (1) of Example 1.

### (2) Preparation of the Polarizing Plate

The polarizing plate was prepared in the same manner as in (2) of Example 1 by sandwiching it between supports. Then, the polarizing plate and a reflection-type polarizer (brightness enhancement film DBEF Qv2 (produced by 3M Company) were laminated using a pressure-sensitive adhesive layer. During this process, the transmission axis of the absorption-type polarizer was disposed parallel to the transmission axis of the reflection-type polarizer. The optical characteristics of the obtained laminate-type polarizing plate at a wavelength of 400 nm were as follows: Ts₄₀₀ was 35.70%, Tp₄₀₀ was 27.48%, Tc₄₀₀ was 0.0151%, and P₄₀₀ was 99.95%.

(3) Evaluation of Polarization Characteristics with Respect to the Light Source

It was calculated in the same manner as in Example 1. The evaluation results are shown in Table 1. However, the evaluation was performed using the laminate-type polarizing plate of (2) of Example 6 and the polarizing plate of (2) of Example 1. The test specimen was combined so that the configuration, from the light source side, was arranged as follows: reflection-type polarizer/pressure-sensitive adhesive layer/second support/absorption-type polarizer/first support and second support/absorption-type polarizer/first support. Spectroscopic measurements were then performed, and the values of Tp and Te were obtained. Based on these, Xp₃₈₀₋₄₄₀, Xc₃₈₀₋₄₄₀, and Xp₃₈₀₋₄₄₀/Xc₃₈₀₋₄₄₀ were calculated.

### Example 7

### (1) Preparation of Absorption-Type Polarizer

The preparation of the absorption-type polarizer is the same as the absorption-type polarizer produced in (1) of Example 1.

### (2) Preparation of the Polarizing Plate

As the first support, a TAC-based film (P980RR, film thickness 80 μm produced by TacBright Optronics Corporation) was used, which had been subjected to saponification treatment (immersion in a 2N sodium hydroxide aqueous solution at 40° C. for 10 minutes) and contains an ultraviolet absorber. As the second support, a TAC-based film (13SG80S-LH, film thickness 80 μm produced by Island Polymer Industries GmbH) was used, which had also been subjected to saponification treatment and did not contain an ultraviolet absorber. As a result, the polarizing plate was obtained in which only one side of the support contains the ultraviolet absorber. The optical characteristics of the obtained polarizing plate are shown in Table 1.

(3) Evaluation of Polarization Characteristics with Respect to the Light Source

The polarization characteristics with respect to the light source were calculated in the same manner as in Example 1, and the evaluation results are shown in Table 1.

### Example 8

### (1) Preparation of Absorption-Type Polarizer

For the preparation of the absorption-type polarizer, following dyes 1 to 4 were provided according to Example 1 of JP 11-218611 A.

### Dye 1:

C.I. Direct Orange 39, as described in (1) of Example 2, was used.

### Dye 2:

C.I. Direct Red 81 (produced by NIPPON CHEMICAL WORKS Co., Ltd.) was used.

### Dye 3:

A dye represented by Formula (7) was synthesized according to the disclosure of Example 38 in JP 60-156759 A.

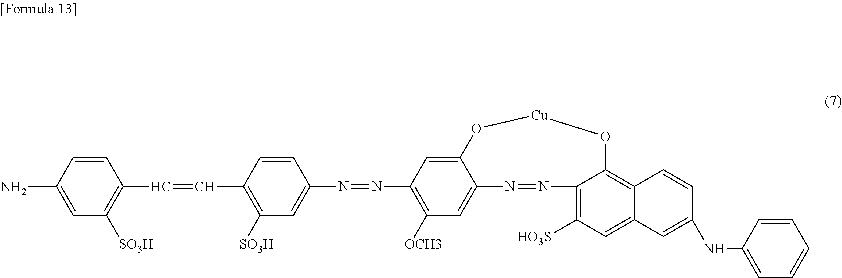

### Dye 4:

A dye represented by Formula (8) was synthesized according to the description of JP 11-218611 A.

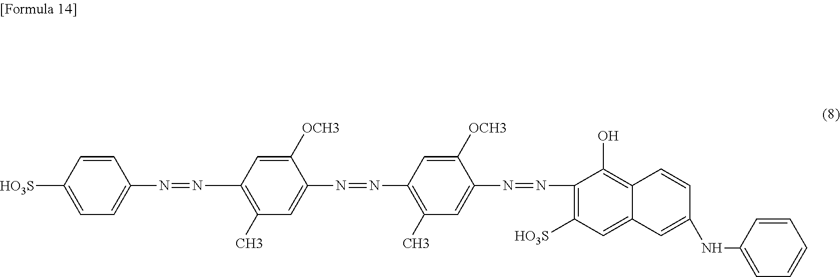 [SMILES: COc1cc(N=Nc2ccc(S(=O)(=O)O)cc2)c(C)cc1N=Nc1cc(OC)c(N=Nc2c(S(=O)(=O)O)cc3cc(Nc4ccccc4)ccc3c2O)cc1C]

Next, these dyes and sodium sulfate were dissolved in water to prepare a dyeing solution. The other processes were performed in the same manner as described in Example 1.

As a result, an absorption-type polarizer exhibiting a gray color was obtained. The optical characteristics of this polarizer were as follows: Ys was 38.11%, Yc was 0.0076%, and Py was 99.97%.

### (2) Preparation of the Polarizing Plate

The polarizing plate was prepared in the same manner as in (2) of Example 1. The optical characteristics of the polarizing plate at a wavelength of 400 nm were measured in the same manner as in (2) of Example 1, and the results were as follows: Ts₄₀₀ was 31.55%, Tp₄₀₀ was 19.89%, Tc₄₀₀ was 0.0137%, and P₄₀₀ was 99.93%. These values are shown in Table 1 as the optical characteristics of the polarizing plate.

(3) Evaluation of Polarization Characteristics with Respect to the Light Source

It was calculated in the same manner as in Example 1, and the evaluation results are shown in Table 1.

### Comparative Example 1

As an iodine-based absorption-type polarizing plate, SKN-18043T (produced by Nippon Kayaku Co., Ltd.) was used. This polarizing plate exhibited a gray color and had a configuration in which an absorption-type polarizer, in which iodine was oriented as a colorant, was sandwiched between TAC-based support films that did not contain an ultraviolet absorber. The optical characteristics of this polarizing plate were as follows: Ys was 43.08%, Yc was 0.0038%, and Py was 99.99%.

The optical characteristics of the polarizing plate at a wavelength of 400 nm were measured in the same manner as in (2) of Example 1, and the results were as follows: Ts₄₀₀ was 15.12%, Tp₄₀₀ was 4.55%, Tc₄₀₀ was 0.0192%, and P₄₀₀ was 99.58%. The measured results are shown in Table 1. Furthermore, it was calculated in the same manner as in Example 1. The evaluation results are shown in Table 1.

### Comparative Example 2

As an iodine-based absorption-type polarizing plate, SKN-18243T (produced by Nippon Kayaku Co., Ltd.) was used, which applied to general LCD. This polarizing plate exhibited a gray color and had a configuration in which an absorption-type polarizer, in which iodine—was oriented as a colorant, was sandwiched between TAC-based support films that contains an ultraviolet absorber. The optical characteristics of this polarizing plate were as follows: Ys was 42.97%, Yc was 0.0032%, and Py was 99.99%.

The optical characteristics of the polarizing plate at a wavelength of 400 nm were measured in the same manner as in (2) of Example 1, and the results were as follows: the single transmittance Ts₄₀₀ was 31.88%, the parallel transmittance Tp₄₀₀ was 20.24%, the cross transmittance Tc₄₀₀ was 0.0874%, and the degree of polarization P₄₀₀ was 99,57%. The measured results are shown in Table 1. Furthermore, it was calculated in the same manner as in Example 1. The evaluation results are shown in Table 1.

### Comparative Example 3

### (1) Preparation of Absorption-Type Polarizer

The absorption-type polarizer was prepared in the same manner as in (1) of Example 8.

### (2) Preparation of the Polarizing Plate

The polarizing plate was produced in the same manner as in 1) of Example 1, except that a TAC-based film (P₉₈₀RR, film thickness 80 μm produced by TacBright Optronics Corporation), which had been subjected to saponification treatment (immersion in a 2N sodium hydroxide aqueous solution at 40° C. for 10 minutes) and contains an ultraviolet absorber, was used as both the first support and the second support. This resulted in a polarizing plate with ultraviolet absorbers contained in both of the support. The optical characteristics of the polarizing plate at a wavelength of 400 nm were measured in the same manner as in (2) of Example 1, and the results were as follows: Ts₄₀₀ was 26.18%, Tp₄₀₀ was 6.25%, Tc₄₀₀ was 0.0002%, and P₄₀₀ was 99.99%. The optical characteristics of the obtained polarizing plate are shown in Table 1.

(3) Evaluation of Polarization Characteristics with Respect to the Light Source

It was calculated in the same manner as in Example 1. The evaluation results are shown in Table 1.

### Comparative Example 4

### (1) Preparation of Absorption-Type Polarizer

The preparation of the absorption-type polarizer was performed in the same manner as in (1) of Example 8, except that the dyeing solution was diluted by 2 to 3 times to increase the transmittance of the obtained polarizer. The optical characteristics of the obtained absorption-type polarizer were as follows: Ys was 43.54%, Yc was 1.619%, and Py was 95.56%.

### (2) Preparation of the Polarizing Plate

The polarizing plate was prepared in the same manner as in (2) of Comparative Example 3. The optical characteristics of the polarizing plate at a wavelength of 400 nm were measured in the same manner as in (2) of Example 1, and the results were as follows: Ts₄₀₀ was 22.20%, Tp₄₀₀ was 9.20%, Tc₄₀₀ was 0.8200%, and P₄₀₀ was 91.45%.

(3) Evaluation of Polarization Characteristics with Respect to the Light Source

It was calculated in the same manner as in Example 1. The evaluation results are shown in Table 1.

### Comparative Example 5

### (1) Preparation of Absorption-Type Polarizer

The absorption-type polarizer was prepared in the same manner as in (1) of

### Comparative Example 4

### (2) Preparation of the Polarizing Plate

The polarizing plate was prepared in the same manner as in (2) of Example 1. The optical characteristics of the polarizing plate at a wavelength of 400 nm were measured in the same manner as in (2) of Example 1, and the results were as follows: Ts₄₀₀ was 42.23%, Tp₄₀₀ was 32.30%, Tc₄₀₀ was 3.3749%, and P₄₀₀ was 90.04%. These values are shown in Table 1 as the optical characteristics of the polarizing plate.

(3) Evaluation of Polarization Characteristics with Respect to the Light Source

The evaluation of the polarization characteristics with respect to the light source was calculated in the same manner as in Example 1. The evaluation results are shown in Table 1.

### Comparative Example 6

### (1) Preparation of Absorption-Type Polarizer

The preparation of the absorption-type polarizer is the same manner as in (1) of Example 4, except that the dyeing solution was diluted by 1.5 to 2 times to increase the transmittance of the obtained polarizer. The optical characteristics of the obtained absorption-type polarizer at a wavelength of 400 nm were as follows: Ts₄₀₀ was 39.02%, Tp₄₀₀ was 30.26%, Tc₄₀₀ was 0.1881%, and the degree of polarization P₄₀₀ was 99.38%.

### (2) Preparation of the Polarizing Plate

The polarizing plate was prepared in the same manner as in (2) of Example 1. In the optical characteristics of the obtained polarizing plate, no difference was observed compared to the optical characteristics of the absorption-type polarizer prepared in (1) of Comparative Example 6. These values are shown in Table 1 as the optical characteristics of the polarizing plate.

(3) Evaluation of Polarization Characteristics with Respect to the Light Source

The evaluation of the polarization characteristics with respect to the light source were calculated in the same manner as in Example 1. The evaluation results are shown in Table 1.

### Comparative Example 7

The preparation of the absorption-type polarizer is the same manner as in (1) of Example 5, except that the dyeing solution was diluted by 1.5 to 2 times to increase the transmittance of the obtained polarizer. The optical characteristics of the obtained absorption-type polarizer at a wavelength of 400 nm were as follows: Ts₄₀₀ was 39.02%, Tp₄₀₀ was 30.26%, Tc₄₀₀ was 0.1881%, and the degree of polarization P₄₀₀ was 99.38%.

### (2) Preparation of the Polarizing Plate

The polarizing plate was prepared in the same manner as in (2) of Example 1. In the optical characteristics of the obtained polarizing plate, no difference was observed compared to the optical characteristics of the absorption-type polarizer prepared in (1) of Comparative Example 7. These values are shown in Table 1 as the optical characteristics of the polarizing plate.

(3) Evaluation of Polarization Characteristics with Respect to the Light Source

The evaluation of the polarization characteristics with respect to the light source were calculated in the same manner as in Example 1. The evaluation results are shown in Table 1.

### Comparative Example 8

### (1) Preparation of Absorption-Type Polarizer

The absorption-type polarizer was prepared in the same manner as in (1) of Example 8.

### (2) Preparation of the Polarizing Plate

The polarizing plate was prepared in the same manner as in (2) of Example 7, resulting in a polarizing plate with an ultraviolet absorber contained on one side. Also, the optical characteristics of the polarizing plate at a wavelength of 400 nm were measured in the same manner as in (2) of Example 7, and the results were as follows: Ts₄₀₀ was 21.8%, Tp₄₀₀ was 14.35%, Tc₄₀₀ was 0.0032%, and P₄₀₀ was 99.98%. The measured results are shown in Table 1.

(3) Evaluation of Polarization Characteristics with Respect to the Light Source

The polarization characteristics with respect to the light source were calculated in the same manner as in Example 7. The evaluation results are shown in Table 1.

### Comparative Example 9

### (1) Preparation of Absorption-Type Polarizer

The preparation of the absorption-type polarizer is the same as the absorption-type polarizer produced in (1) of Example 1.

### (2) Preparation of the Polarizing Plate

The polarizing plate was prepared in the same manner as in (2) of Comparative Example 3, resulting in a polarizing plate with ultraviolet absorbers contained in both side supports. The optical characteristics of the polarizing plate at a wavelength of 400 nm were measured in the same manner as in (2) of Example 1, and the results were as follows: Ts₄₀₀ was 26.18%, Tp₄₀₀ was 6.25%, Tc₄₀₀ was 0.0002%, and P₄₀₀ was 99.99%. The optical characteristics of the obtained polarizing plate are shown in Table 1.

(3) Evaluation of Polarization Characteristics with Respect to the Light Source

The evaluation of the polarization characteristics with respect to the light source were calculated in the same manner as in Example 1. The evaluation results are shown in Table 1. Note that, when no maximum absorption wavelength λmax was present in the range of 370 to 470 nm, it was indicated as “-”.

TABLE 1

| | | | Optical characteristics of polarizing | | | | Polarization characteristics | | | Ultraviolet |
|---|---|---|---|---|---|---|---|---|---|---|
| | | Absorption | plato at wavelength 400 nm | | | | with respect to light source | | | absorption |
| | | type polarizer | Ts₄₀₀ | | Tc₄₀₀ | | Xp₃₈₀₋₄₄₀ | Xc₃₈₀₋₄₄₀ | Xp₃₈₀₋₄₄₀/ | layer in |
| | Dichroic colorant | λmax | (%) | Tp₄₀₀ (%) | (%) | P₄₀₀ (%) | (%) | (%) | Xc₃₈₀₋₄₄₀ | optical path |
| Example 1 | Dye-based single color | 406 nm | 38.77 | 30.06 | 0.0011 | 99.99 | 30.21 | 0.0017 | 18095 | None |
| Example 2 | Dye-based single color | 447 nm | 39.04 | 30.45 | 0.0371 | 99.88 | 30.31 | 0.0453 | 869 | None |
| Example 3 | Dye-based single color | Same as Example 2 | 35.58 | 25.32 | 0.0041 | 99.98 | 25.17 | 0.0065 | 3880 | None |
| Example 4 | Dyc-based single color | 462 nm | 38.43 | 25.07 | 0.0400 | 99.84 | 25.11 | 0.0392 | 841 | None |
| Example S | Dve-based single cokr | 465 nm | 38.78 | 25.59 | 0.0117 | 99.95 | 25.20 | 0.0170 | 1488 | None |
| Example 6 | Dye-based single color | Same as Example 1 | 35.70 | 27.48 | 0.0181 | 99.95 | 27.40 | 0.0181 | 1517 | None |
| Example 7 | Dve-based single color | Same as Example 1 | 26.18 | 20.30 | 0.0007 | 99.99 | 20.68 | 0.0009 | 24239 | 1 layer |
| Example 8 | Dye-based cofor mixture | Same as Example 2 | 31.55 | 19.89 | 0.0137 | 98.93 | 20.06 | 0.0132 | 1514 | None |
| Comparative | Iodine-based | — | 31.88 | 20.24 | 0.0874 | 99.57 | 21.11 | 0.0814 | 259 | None |
| Example 1 | | | | | | | | | | |
| Comparative | Iodine-based | — | 15.12 | 4.55 | 0.0192 | 99.58 | 8.37 | 0.0232 | 361 | 4 layer |
| Example 2 | | | | | | | | | | |
| Comparative | Dye-based color mixture | Same as Example 2 | 16.50 | 5.51 | 0.0061 | 99.89 | 8.51 | 0.0064 | 1326 | 4 layer |
| Example 3 | | | | | | | | | | |
| Comparative | Dye-based color mixture | Same as Example 2 | 22.20 | 9.20 | 0.8200 | 91.45 | 13.45 | 1.0770 | 12 | 4 layer |
| Example 4 | | | | | | | | | | |
| Comparative | Dye-based color mixture | Same as Example 2 | 42.23 | 32.30 | 3.3749 | 90.04 | 32.41 | 3.2439 | 10 | None |
| Example 5 | | | | | | | | | | |
| Comparative | Dye-based color mixture | Same as Example 4 | 39.00 | 30.09 | 0.3275 | 98.92 | 30.06 | 0.2864 | 105 | None |
| Example 6 | | | | | | | | | | |
| Comparative | Dye-based color mixture | Same as Example 5 | 39.02 | 30.26 | 0.1881 | 99.38 | 30.30 | 0.1911 | 159 | None |
| Example 7 | | | | | | | | | | |
| Comparative | Dye-based color mixture | Same as Example 2 | 21.80 | 14.35 | 0.0032 | 99.98 | 14.48 | 0.0057 | 2540 | 1 layer |
| Example 8 | | | | | | | | | | |
| Comparative | Dye-based color mixture \| | Same as Example 1 | 26.18 | 6.25 | 0.0002 | 99.99 | 9.08 | 0.0003 | 28916 | 4 layer |
| Example 9 | | | | | | | | | | |

In Table 1, the number of ultraviolet absorption layers in the optical path corresponds to the number of supports in the combined polarizing plates.

From Table 1, it was found that the absorption-type polarizers of Examples 1 to 8, having a Tp₄₀₀ of approximately 20 to 30% and a P₄₀₀ of 99.8% or more, could be obtained by adjusting the colorant concentration in the polarizer and providing either no ultraviolet absorption layer or a single layer, and the absorption-type polarizers of Examples 1 to 8 have high optical characteristics.

When the polarization characteristics with respect to the light source were evaluated for these polarizing plates, the polarizing plates of Examples 1 to 8 exhibited an Xp₃₈₀₋₄₄₀ of approximately 20 to 30% or more and an Xc₃₈₀₋₄₄₀ of approximately 0.0001 to 0.1%. In particular, Examples 1 to 6 exhibited an Xp₃₈₀₋₄₄₀ approximately 1.5 to 3.5 times or more than that of Comparative Examples 1 to 4, which are conventional polarizing plates for LCDs. This means that even if the illuminance of the light source is reduced by this multiple, the resin can still be cured in the same amount of illuminance time as with the conventional polarizing plate, or the curing time of the resin can be shortened by that multiple.

In addition, Xp₃₈₀₋₄₄₀/Xc₃₈₀₋₄₄₀ for Examples 1 to 8 was calculated to be approximately 600 to 24000. On the other hand, while Xp₃₈₀₋₄₄₀ in Comparative Examples 1 to 8 was found to be approximately 8 to 30% or more, indicating high light transmittance, the Xc₃₈₀₋₄₄₀ values were more than those of the examples, resulting in insufficient light shielding properties. As a result, Xp₃₈₀₋₄₄₀/Xc₃₈₀₋₄₄₀ was calculated to be approximately 10 to 2500. Therefore, Xp₃₈₀₋₄₄₀/Xc₃₈₀₋₄₄₀ of Examples 1 to 8 is improved by 10 to 100 times or more than those of Comparative Examples 1 to 8, allowing the design of liquid crystal shutters with significantly improved the utilization efficiency of the light source.

Example 6 is an example of using a laminate-type polarizing plate in which a reflection-type polarizer is laminated to the polarizing plate of Example 1. By installing such a laminate-type polarizing plate on the light source side of a liquid crystal panel, the liquid crystal shutter performance is prevented from degrading. The polarization in the vibration direction, which would be absorbed by the absorption-type polarizing plate, is reflected by the reflection-type polarizer in advance. This suppresses a decrease in the transmittance of light from the light source while reducing degradation of the polarizing plate caused by light in the wavelength range of 380 to 440 nm.

Example 7 has the same configuration as the polarizing plate in Example 1, except that a single layer of a support containing an ultraviolet absorber is provided on the light source side of the apparatus. Even when applying this polarizing plate, Xp₃₈₀₋₄₄₀ was maintained at approximately 20%, and Xp₃₈₀₋₄₄₀/Xc₃₈₀₋₄₄₀ was equal to or more than that of Example 1. This configuration can improve the utilization efficiency of light source of the liquid crystal shutter while reducing the light degradation of the polarizing plate on the light source side due to ultraviolet light contained in the light source.

Example 8 uses a dye-based polarizing plate made from a color mixture that exhibits gray color. In this case, by eliminating the ultraviolet absorption layer in the optical path, the polarization characteristics with respect to the light source were achieved at the same level or better than those obtained when using the iodine-based polarizing plate without an ultraviolet absorption layer in the optical path, as in Comparative Example 1, and also providing high light resistance.

Examples 2, 3, and 8 of the absorption-type polarizers contain the same orange-based colorant. As can be seen from the evaluation results, the absorption-type polarizers in Examples 2 and 3, which are made from a single color, are designed with a better balance in both Xp₃₈₀₋₄₄₀ and Xc₃₈₀₋₄₄₀ compared to the absorption-type polarizer in Example 8, which is made from a color mixture. Therefore, when controlling the polarization characteristics of a specific light source wavelength range in this way, it is more suitable to use a single-color colorant having polarization characteristics in that wavelength range, as it is not influenced by the secondary absorption wavelengths of other colorants.

Comparative Examples 1 and 2 are examples using conventional iodine-based polarizing plates for LCDs. In this case, the degree of polarization at a wavelength of 400 nm is high, 99.5% or more. However, when evaluating the polarization characteristics with respect to the light source, the dichroism in the wavelength range is low, resulting in Xp₃₈₀₋₄₄₀/Xc₃₈₀₋₄₄₀ was approximately 200 to 300. In addition, while Xp₃₈₀₋₄₄₀ increases by not providing an ultraviolet absorption layer in the polarizing plate, there is a problem with light resistance, which means it cannot be used for a long time.

Comparative Example 3 has the same configuration as the polarizing plate in Example 8, except that four layers of ultraviolet absorber in support are provided. Compared to Comparative Example 2, Xc₃₈₀₋₄₄₀ is improved, but Xp₃₈₀₋₄₄₀ does not reach the level of Examples 1 to 8. Therefore, when used as a liquid crystal shutter, the improvement effect compared to Comparative Examples 1 and 2 is low.

Comparative Example 4 has the same configuration as the polarizing plate in Comparative Example 3, except that a polarizing plate with an increased Ys of the absorption-type polarizer is used. In this case, as the colorant content decreases and the dichroism decreases, the polarization characteristics at a wavelength of 400 nm decrease, and simultaneously, the polarization characteristics with respect to the light source degraded compared to Comparative Examples 1 and 2.

In addition, Comparative Example 5 has the same configuration as Comparative Example 4, except that a support without ultraviolet absorber is used. While Xp₃₈₀₋₄₄₀ is numerically improved to a level comparable to the examples, the dichroism in the light source wavelength range is low, resulting in an Xp₃₈₀₋₄₄₀/Xc₃₈₀₋₄₄₀ is as low as 10 and does not function as a liquid crystal shutter.

Comparative Examples 6 and 7 have the same configuration as Examples 4 and 5, except that the amount of colorant in the absorption-type polarizer is reduced to increase the transmittance at a wavelength of 400 nm. As a result, Xp₃₈₀₋₄₄₀ could be the same as Example 1, but due to the λmax of the absorption-type polarizer being on the longer wavelength side compared to Example 1, the cross transmittance curve was unable to optimally cover the light source wavelength range, resulting in a lower Xp₃₈₀₋₄₄₀/Xc₃₈₀₋₄₄₀ than in Comparative Examples 1 and 2.

Comparative Example 8 uses the absorption-type polarizer of Example 8 and, like Example 7, includes one layer of support containing an ultraviolet absorber. In this case, although the polarization characteristics with respect to the light source are improved compared to Comparative Examples 1 and 2, particularly, Xp₃₈₀₋₄₄₀ does not reach the level of Examples 1 to 8, and the improvement effect compared to Comparative Examples 1 and 2 when used as a liquid crystal shutter is low.

Comparative Example 9 uses a polarizing plate in which an absorption-type polarizer is sandwiched by supports containing an ultraviolet absorber of Example 1 on both sides of the liquid crystal panel. In this case, Xc₃₈₀₋₄₄₀ is significantly improved compared to Comparative Examples 2 and 3, but Xp₃₈₀₋₄₄₀ is the same as in Comparative Examples 2 and 3. In this case, the polarizing plate exhibits excellent light resistance and light shielding properties when used as a liquid crystal shutter, but it does not effectively utilize the light source illuminance.

Next, the preparation of the pre-polarizing plate will be specifically described through the following examples.

### Example 9

In (1) of Example 1, except for diluting the dye concentration of the dyeing solution to 2 times the concentration of the conditions in Example 1 with water while maintaining almost the same dyeing time for the PVA-based resin film, the process was performed in the same manner as in Example 1. The optical characteristics of the obtained polarizing plate at a wavelength of 400 nm were as follows: Ts₄₀₀ was 43.14%, Tp₄₀₀ was 36.77%, Tc₄₀₀ was 0.44%, and P₄₀₀ was 98.81%. Similarly to Example 1, the results of calculating Xp₃₈₀₋₄₄₀, Xc₃₈₀₋₄₄₀, and Xp₃₈₀₋₄₄₀/Xc₃₈₀₋₄₄₀ are shown in Table 2.

### Example 10

In (1) of Example 1, except for diluting the dye concentration of the dyeing solution to 5 times the concentration of the conditions in Example 1 with water while maintaining almost the same dyeing time for the PVA-based resin film, the process was performed in the same manner as in Example 1. The optical characteristics of the obtained polarizing plate at a wavelength of 400 nm were as follows: Ts₄₀₀ was 51.89%, Tp₄₀₀ was 41.05%, Tc₄₀₀ was 12.81%, and P₄₀₀ was 72.42%. Similarly to Example 1, the results of calculating Xp₃₈₀₋₄₄₀, Xc₃₈₀₋₄₄₀, and Xp₃₈₀₋₄₄₀/Xc₃₈₀₋₄₄₀ are shown in Table 2.

### Example 11

In (1) of Example 1, except for diluting the dye concentration of the dyeing solution to 10 times the concentration of the conditions in Example 1 with water while maintaining almost the same dyeing time for the PVA-based resin film, the process was performed in the same manner as in Example 1. The optical characteristics of the obtained polarizing plate at a wavelength of 400 nm were as follows: Ts₄₀₀ was 61.84%, Tp₄₀₀ was 45.06%, Tc₄₀₀ was 28.97%, and P₄₀₀ was 46.63%. Similarly to Example 1, the results of calculating Xp₃₈₀₋₄₄₀, Xc₃₈₀₋₄₄₀, and Xp₃₈₀₋₄₄₀/Xc₃₈₀₋₄₄₀ are shown in Table 2.

### Example 12

In (1) of Example 1, except for diluting the dye concentration of the dyeing solution to 40 times the concentration of the conditions in Example 1 with water while maintaining almost the same dyeing time for the PVA-based resin film, the process was performed in the same manner as in Example 1. The optical characteristics of the obtained polarizing plate at a wavelength of 400 nm were as follows: Ts₄₀₀ was 69.12%, Tp₄₀₀ was 52.12%, Tc₄₀₀ was 43.44%, and P₄₀₀ was 30.13%. Similarly to Example 1, the results of calculating Xp₃₈₀₋₄₄₀, Xc₃₈₀₋₄₄₀, and Xp₃₈₀₋₄₄₀/Xc₃₈₀₋₄₄₀ are shown in Table 2.

### Example 13

In (1) of Example 1, except for diluting the dye concentration of the dyeing solution to 80 times the concentration of the conditions in Example 1 with water while maintaining almost the same dyeing time for the PVA-based resin film, the process was performed in the same manner as in Example 1. The optical characteristics of the obtained polarizing plate at a wavelength of 400 nm were as follows: Ts₄₀₀ was 79.46%, Tp₄₀₀ was 64.38%, Tc₄₀₀ was 61.90%, and P₄₀₀ was 14.03%. Similarly to Example 1, the results of calculating Xp₃₈₀₋₄₄₀, Xc₃₈₀₋₄₄₀, and Xp₃₈₀₋₄₄₀/Xc₃₈₀₋₄₄₀ are shown in Table 2.

The optical characteristics of the obtained polarizing plates obtained in Example 9 to 13 are shown in Table 2.

TABLE 2

| | Optical characteristics of polarizing | | | | Polarization characteristics | | |
|---|---|---|---|---|---|---|---|
| | plato at wavelength 400 nm | | | | with respect to light source | | |
| | Ts₄₀₀ (%) | Tp₄₀₀ (%) | Tc₄₀₀ (%) | P₄₀₀ (%) | Xp₃₈₀₋₄₄₀ (%) | Xc₃₈₀₋₄₄₀ (%) | Xp₃₈₀₋₄₄₀/Xc₃₈₀₋₄₄₀ |
| Example 9 | 43.14 | 36.77 | 0.44 | 98.81 | 36.88 | 0.50 | 73.8 |
| Example 10 | 51.89 | 41.05 | 12.81 | 72.42 | 41.17 | 13.17 | 3.3 |
| Example 11 | 60.84 | 45.06 | 28.97 | 46.63 | 45.29 | 29.39 | 1.5 |
| Example 12 | 89.12 | 52.12 | 43.44 | 30.13 | 52.40 | 43.84 | 1.2 |
| Example 13 | 79.46 | 64.38 | 61.80 | 14.03 | 64.98 | 62.68 | 1.0 |

From the results of Examples 9 to 13, it was confirmed that by adjusting the concentration of the dyeing solution during the stretching process, Ts₄₀₀ ranged from 43 to 79%, enabling the preparation of a polarizing plate with high transmittance that is suitably used as a pre-polarizing plate used in a photofabrication apparatus.

Next, the light resistance test of the polarizing plate will be specifically described through the following examples.

### Example 14

### (4) Light Resistance Test of Polarizing Plate

A polarizing plate prepared in Example 1 was cut into a square of 5 cm and adhered to a glass plate via an acrylic resin-based pressure-sensitive adhesive layer (PTR-3000, film thickness 25 μm produced by Nippon Kayaku Co., Ltd.) to prepare a test specimen. Next, a UV-LED lamp having a maximum emission wavelength around 400 nm was used as the light source, and the output of the light source was set to 0.8 W/cm². The test specimen was disposed so that the distance between the light source and the polarizing plate surface side of the test specimen was 1 cm. Light irradiation was then carried out. After testing, the optical characteristics (Ts₄₀₀, Tp₄₀₀, Tc₄₀₀, and P₄₀₀) of the irradiated section of the test specimen were measured, and Xc₃₈₀₋₄₄₀, Xp₃₈₀₋₄₄₀, and Xp₃₈₀₋₄₄₀/Xc₃₈₀₋₄₄₀ were calculated. In addition, visual inspection was performed to evaluate the appearance for any color changes or occurrence of damage. Here, the optical characteristics of the polarizing plate before testing were the same as those in Example 1.

### Example 15

A polarizing plate prepared in Example 11 was cut into a square of 5 cm and adhered to a glass plate via an acrylic resin-based pressure-sensitive adhesive layer (PTR-3000, film thickness 25 μm produced by Nippon Kayaku Co., Ltd.) to prepare a pre-polarizing plate. A glass surface of pre-polarizing plate was overlaid so that its transmission axis was parallel to that of the polarizing plate surface of the test specimen prepared in Example 14. Except that a pre-polarizing plate was installed in the optical path between the light source and the test specimen, the same as (4) of Example 14. Here, the value of optical characteristics of the polarizing plate before testing were the same as in Example 1, and no measurements were performed for the polarizing plate used in Example 11.

### Comparative Example 10

Except that the test specimen was prepared using the polarizing plate prepared in Comparative Example 1, the same as (4) of Example 14. Here, the optical characteristics of the polarizing plate before testing were the same as those in Comparative Example 1.

The light resistance test results for the polarizing plates in Examples 14 and 15 and Comparative Example 10 are shown in Table 3.

TABLE 3

| | | Optical characteristics of polarizing | | | | Polarization characteristics | | | |
|---|---|---|---|---|---|---|---|---|---|
| | Test time | plato at wavelength 400 nm | | | | with respect to light source | | | Appearance evaluation |
| | (hour) | Ts₄₀₀ (%) | Tp₄₀₀ (%) | Tc₄₀₀ (%) | P₄₀₀ (%) | Xp₃₈₀₋₄₄₀ (%) | Xc₃₈₀₋₄₄₀ (%) | Xp₃₈₀₋₄₄₀/Xc₃₈₀₋₄₄₀ | (Irradiated section) |
| Example 14 | 100 | 37.22 | 29.98 | 0.006 | 99.98 | 30.02 | 0.011 | 2729 | |
| | 500 | 36.00 | 28.22 | 0.025 | 89.91 | 29.85 | 0.031 | 963 | |
| Example 15 | 100 | 38.14 | 30.01 | 0.005 | 99.98 | 30.07 | 0.008 | 3759 | |
| | 800 | 37.46 | 29.77 | 0.010 | 99.97 | 30.01 | 0.015 | 2001 | |
| Comparative | 100 | 24.34 | 15.21 | 0.073 | 99.52 | 15.44 | 0.076 | 203 | |
| Example 10 | | | | | | | | | |

From the results of the light resistance test of the polarizing plates, in the case of Example 14, even after prolonged light irradiation for 500 hours, high optical characteristics were maintained, and no visible changes were observed in the irradiated section.

Example 15 is a case where a pre-polarizing plate (Example 11) was installed in the optical path. For change of optical characteristics of the polarizing plate, the decrease in the optical characteristics was more suppressed compared to Example 14, and no visible changes were observed in the irradiated section. This showed that by using a pre-polarizing plate, the optical characteristics of the polarizing plate on the liquid crystal panel side can further suppress the decrease at the expense of the degradation of the pre-polarizing plate.

In the case of Comparative Example 10, a decrease in Tp₄₀₀ (and Xp₃₈₀₋₄₄₀) was observed after 100 hours of light irradiation, and a reddish discoloration of the irradiated section was observed. This phenomenon is presumed to be due to the polyene formation of the iodine-based polarizer. A decrease in Tp₄₀₀ (and Xp₃₈₀₋₄₄₀) reduces the irradiation intensity from the light source, which can lead to delayed curing of the resin or defective curing in an actual photofabrication apparatus.

### INDUSTRIAL APPLICABILITY

The polarizing plate of the present invention is suitable for a photofabrication apparatus equipped with a liquid crystal panel as a liquid crystal shutter. Compared to conventional polarizing plates for liquid crystal display, it can improve the utilization efficiency of the light source. As a result, in addition to achieving power savings by reducing the amount of light emitted from the light source, it can also prevent degradation of the polarizing plate due to ultraviolet light exposure. This reduces the frequency of liquid crystal panel replacements caused by degradation of polarizing plate.

### REFERENCE SIGNS LIST

10 First support
11 Second support
20 Absorption-type polarizer
21 Reflection-type polarizer (polarizing plate)
30 Pressure-sensitive adhesive layer
100 Polarizing plate
101 Laminate-type polarizing plate
102 Polarizing plate (pre-polarizing plate)
40 Photo-curable resin
41 Light source (UV-LED)
42 Platform
43 Fabricated object
44 Resin tray
110 Liquid crystal cell
200 Liquid crystal panel
300 Photofabrication apparatus

1. A polarizing plate for use in a liquid crystal shutter of a photofabrication apparatus,
wherein the polarizing plate comprises an absorption-type polarizer in which a dichroic colorant is oriented,
the absorption-type polarizer has a maximum absorption wavelength in a wavelength range of 370 to 470 nm, and
the polarizing plate has an Xp₃₈₀₋₄₄₀ of 20% or more as determined by Expression (1), and an Xc₃₈₀₋₄₄₀ of 0.0001 to 0.1% as determined by Expression (2):
$$\begin{matrix}[ Expression 1 ] & \\ {X}_{P 380 - 440} = \frac{{\int }_{380}^{440} Tp ( λ ) S ( λ ) d λ}{{\int }_{380}^{440} S ( λ ) d λ} \times 100 & ( 1 )\end{matrix}$$
$$\begin{matrix}[ Expression 2 ] & \\ {X}_{C 380 - 440} = \frac{{\int }_{380}^{440} Tc ( λ ) S ( λ ) d λ}{{\int }_{380}^{440} S ( λ ) d λ} \times 100 & ( 2 )\end{matrix}$$
wherein Xp₃₈₀₋₄₄₀ is the weighted parallel transmittance calculated in a wavelength range of 380 nm to 440 nm; Xc₃₈₀₋₄₄₀ is a weighted cross transmittance calculated in a wavelength range of 380 nm to 440 nm; Tp(λ) is a parallel transmittance of the polarizing plate at each wavelength; Tc(λ) is a cross transmittance of the polarizing plate at each wavelength; and S(λ) is a light source illuminance normalized at the maximum illuminance.

2. The polarizing plate according to claim 1, comprising, as the dichroic colorant, at least one of azo compounds described in the following Formulas (1) to (3) or salts thereof: 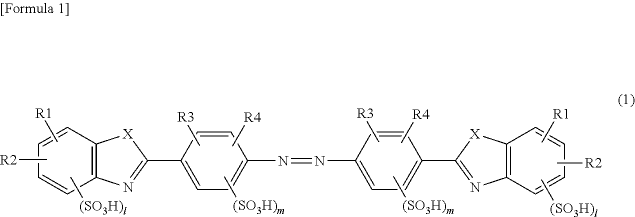
wherein Formula (1) is expressed in the form of a free acid, wherein R1 and R2 represent a hydrogen atom, a halogen atom, a lower alkyl group, a lower alkoxy group, or a carboxyl group; R3 and R4 represent a hydrogen atom, a halogen atom, a lower alkyl group, a lower alkoxy group, or a hydroxyl group; and X represents O, S, NH or NCH₃; and 1 and m represent 0, 1, or 2, and 1+m>0; 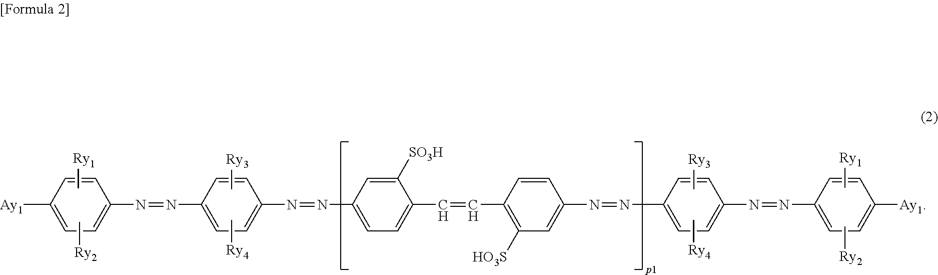
wherein Formula (2) is expressed in the form of a free acid, wherein Ay₁ represents a sulfo group, a carboxyl group, a hydroxyl group, an alkyl group having 1 to 4 carbon atoms, or an alkoxy group having 1 to 4 carbon atoms; Ry₁ to Ry₄ each independently represent a hydrogen atom, a sulfo group, an alkyl group having 1 to 4 carbon atoms, or an alkoxy group having 1 to 4 carbon atoms; and p1 is an integer of 1 to 3; 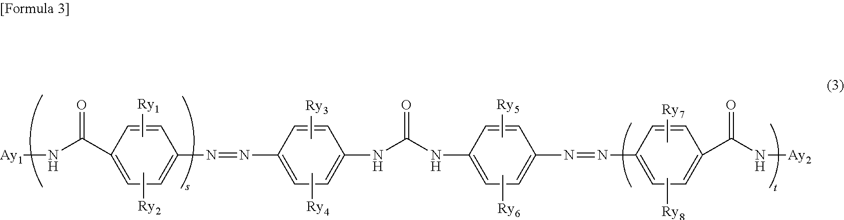
wherein Formula (3) is expressed in the form of a free acid, wherein Ay₁ and Ay₂ are each independently a naphthyl group optionally having a substituent, or a phenyl group optionally having a substituent; s and t are each independently 0 or 1; and either s or t is 1; and Ry₁ to Ry: are each independently a hydrogen atom or a substituent.

3. The polarizing plate according to claim 1 comprising a reflection-type polarizer, wherein the reflection-type polarizer and the absorption-type polarizer are laminated so that transmission axes thereof are parallel.

4. A liquid crystal panel with a TFT driving type, comprising the polarizing plate according to claim 1.

5. A photofabrication apparatus comprising the liquid crystal panel according to claim 4 and an LED light source,
wherein the liquid crystal panel controls transmittance of light emitted from the light source;
the light transmitted through the liquid crystal panel cures photo-curable resin; and
the cured resin is sequentially laminated to form a three-dimensional fabricated object.

6. A liquid crystal panel comprising the polarizing plate according to claim 1,
wherein the liquid crystal panel is of TFT driving type;
the liquid crystal panel has an incident side of light source and an emission side of light source; and
the polarizing plate provided on the incident side comprises a reflection-type polarizer; and
the reflection-type polarizer and the absorption-type polarizer are laminated so that transmission axes thereof are parallel.

7. A photofabrication apparatus comprising the liquid crystal panel according to claim 6 and an LED light source,
wherein the liquid crystal panel controls transmittance of light emitted from the light source;
the light transmitted through the liquid crystal panel cures a photo-curable resin; and
the cured resin is sequentially laminated to form a three-dimensional fabricated object.

8. A polarizing plate for use in an optical path between a liquid crystal panel of a photofabrication apparatus and a light source,
wherein the polarizing plate comprises an absorption-type polarizer in which a dichroic colorant is oriented,
the absorption-type polarizer has a maximum absorption wavelength in a wavelength range of 370 to 470 nm; and
the polarizing plate has an Xp₃₈₀₋₄₄₀ of 30 to 70% as determined by Expression (1), and an Xc₃₈₀₋₄₄₀ of 0.1 to 65% as determined by Expression (2):
$$\begin{matrix}[ Expression 3 ] & \\ {X}_{P 380 - 440} = \frac{{\int }_{380}^{440} Tp ( λ ) S ( λ ) d λ}{{\int }_{380}^{440} S ( λ ) d λ} \times 100 & ( 1 )\end{matrix}$$
$$\begin{matrix}[ Expression 4 ] & \\ {X}_{C 380 - 440} = \frac{{\int }_{380}^{440} Tc ( λ ) S ( λ ) d λ}{{\int }_{380}^{440} S ( λ ) d λ} \times 100 & ( 2 )\end{matrix}$$
wherein Xp₃₈₀₋₄₄₀ is a weighted parallel transmittance calculated in a wavelength range of 380 nm to 440 nm; Xc₃₈₀₋₄₄₀ is a weighted cross transmittance calculated in a wavelength range of 380 nm to 440 nm; Tp(λ) is a parallel transmittance of the polarizing plate at each wavelength; Tc(λ) is a cross transmittance of the polarizing plate at each wavelength; and S(λ) is a light source illuminance normalized at the maximum illuminance.

9. The polarizing plate according to claim 8, wherein the dichroic colorant contains at least one of azo compounds of (1) to (3) or salts thereof: 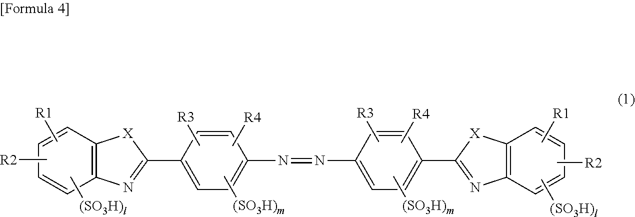
wherein Formula (1) is expressed in the form of a free acid, wherein R¹ and R2 represent a hydrogen atom, a halogen atom, a lower alkyl group, a lower alkoxy group, or a carboxyl group; R3 and R4 represent a hydrogen atom, a halogen atom, a lower alkyl group, a lower alkoxy group, or a hydroxyl group; and X represents O, S, NH or NCH₃; and 1 and m represent 0, 1, or 2; and 1+m>0; 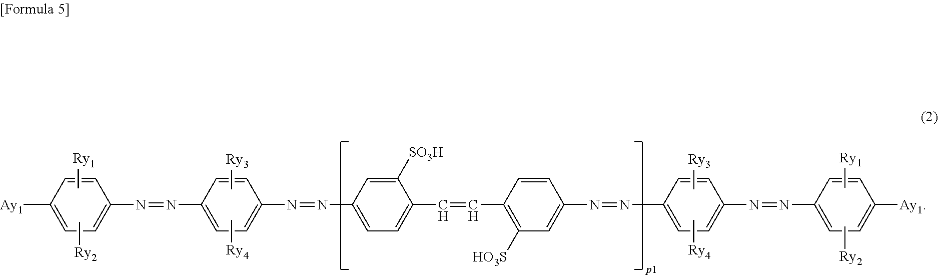
wherein Formula (2) is expressed in the form of a free acid, wherein Ay₁ represents a sulfo group, a carboxyl group, a hydroxyl group, an alkyl group having 1 to 4 carbon atoms, or an alkoxy group having 1 to 4 carbon atoms; Ry₁ to Ry₄ each independently represent a hydrogen atom, a sulfo group, an alkyl group having 1 to 4 carbon atoms; or an alkoxy group having 1 to 4 carbon atoms, and p1 is an integer of 1 to 3; 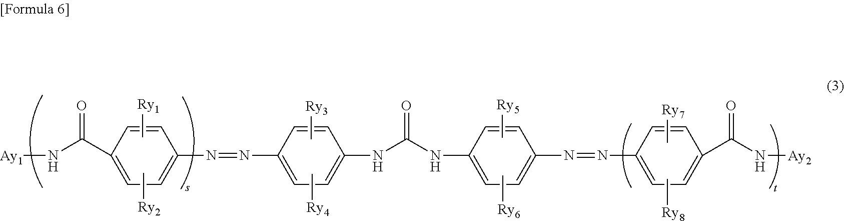
wherein Formula (3) is expressed in the form of a free acid, wherein Ay₁ and Ay₂ are each independently a naphthyl group optionally having a substituent, or a phenyl group optionally having a substituent; s and t are each independently 0 or 1; and either s or t is 1; and Ry₁ to Ry₈ are each independently a hydrogen atom or a substituent.

10. A photofabrication apparatus comprising a liquid crystal panel with a TFT driving type, an LED light source, and the polarizing plate according to claim 8,
wherein the liquid crystal panel comprises the polarizing plate according to claim 1 or 2; and
at least one polarizing plate according to claim 8 or 9 is provided as a pre-polarizing plate in the optical path between the liquid crystal panel and the LED light source, so that the transmittance of light emitted from the light source is controlled by the liquid crystal panel to cure a photo-curable resin, and the cured resin is sequentially laminated to form a three-dimensional fabricated object.

11. The polarizing plate according to claim 2 comprising a reflection-type polarizer, wherein the reflection-type polarizer and the absorption-type polarizer are laminated so that transmission axes thereof are parallel.

12. A liquid crystal panel with a TFT driving type, comprising the polarizing plate according to claim 2.

13. A photofabrication apparatus comprising the liquid crystal panel according to claim 12 and an LED light source,
wherein the liquid crystal panel controls transmittance of light emitted from the light source;
the light transmitted through the liquid crystal panel cures photo-curable resin; and
the cured resin is sequentially laminated to form a three-dimensional fabricated object.

14. A liquid crystal panel comprising the polarizing plate according to claim 2,
wherein the liquid crystal panel is of TFT driving type;
the liquid crystal panel has an incident side of light source and an emission side of light source; and
the polarizing plate provided on the incident side comprises a reflection-type polarizer; and
the reflection-type polarizer and the absorption-type polarizer are laminated so that transmission axes thereof are parallel.

15. A photofabrication apparatus comprising the liquid crystal panel according to claim 14 and an LED light source,
wherein the liquid crystal panel controls transmittance of light emitted from the light source;
the light transmitted through the liquid crystal panel cures a photo-curable resin; and
the cured resin is sequentially laminated to form a three-dimensional fabricated object.

16. A photofabrication apparatus comprising a liquid crystal panel with a TFT driving type, an LED light source, and the polarizing plate according to claim 9,
wherein the liquid crystal panel comprises the polarizing plate according to claim 1 or 2; and
at least one polarizing plate according to claim 8 or 9 is provided as a pre-polarizing plate in the optical path between the liquid crystal panel and the LED light source, so that the transmittance of light emitted from the light source is controlled by the liquid crystal panel to cure a photo-curable resin, and the cured resin is sequentially laminated to form a three-dimensional fabricated object.
